(19) United States
(12) Patent Application Publication
(10) Pub. No.: US 2023/0239313 A1
(43) Pub. Date: Jul. 27, 2023

(54) Systems, Methods, and Apparatuses For Network Entity Tracking

(71) Applicant: Comcast Cable Communications, LLC, Philadelphia, PA (US)

(72) Inventors: Ryan Peters, Arlington, VA (US); Jeffrey Oatess, Arlington, VA (US); Hunar Qadir, Arlington, VA (US); Vincent Santillo, Arlington, VA (US)

(21) Appl. No.: 18/159,226

(22) Filed: Jan. 25, 2023

Related U.S. Application Data
(60) Provisional application No. 63/303,338, filed on Jan. 26, 2022.

(51) Int. Cl. H04L 9/40

(52) U.S. Cl. CPC H04L 63/1416; H04L 63/1425; H04L 63/20

(57) ABSTRACT

Technologies are provided for tracking network entities over time. By analyzing network log data, static identifiers (IDs) may be associated with ephemeral IDs corresponding to respective network entities. Existing associations between static IDs and ephemeral IDs may be updated over time, based on analysis of incoming network log data. Accordingly, an ephemeral ID may correspond to one static ID during a first time period, and may correspond to another static ID during a second time period.

### CROSS-REFERENCE TO RELATED PATENT APPLICATION

This application claims priority to U.S. Provisional Application No. 63/303,338, filed on Jan. 26, 2022, the entirety of which is incorporated by reference herein.

### BACKGROUND

An approach to attempt to identify and track behaviors of network entities (e.g., personal computers, servers, user accounts, etc.) is to centrally collect log data generated by probe devices connected to the network. The log data may be mapped to actions (or behaviors), some of which might indicate a cybersecurity threat. Those actions, over time, may yield baseline behavior that may be used in threat detection or another type of anomaly detection. Baseline behavior of a network entity, however, hinges on tracking of that network entity. Because accessing a ground-truth identity of the network entity is difficult (if not plain unfeasible), commonplace approaches rely on observable identifiers (IDs) in the log data. Yet, relying on such observable IDs does not produce accurate results when analyzing cybersecurity threats.

### SUMMARY

It is to be understood that both the following general description and the following detailed description are exemplary and explanatory only and are not restrictive.

This disclosure covers tracking of network entities over time. A network entity may refer to a component that provides defined functionality within a network of computing devices. As mentioned, examples of a network entity comprise a personal computer (PC), a server, a user device, a user account, and similar components. By analyzing network log data spanning a particular time interval, ephemeral identifiers (IDs) and static IDs may be tracked and compared during specific time periods encompassed by particular time interval. Analysis of the network log data permits associating static identifiers (IDs) and ephemeral IDs corresponding to respective network entities. Existing associations between static IDs and ephemeral IDs may be updated over time, based on analysis of incoming network log data. Accordingly, an ephemeral ID may correspond to one static ID during a first time period, and may correspond to another static ID during a second time period. Monitoring relationships between ephemeral IDs and stable IDs over time (time periods) may be used to better identify malicious actors/devices.

Other examples and configurations are possible. Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The annexed drawings are an integral part of the disclosure and are incorporated into the subject specification. The drawings illustrate example embodiments of the disclosure and, in conjunction with the description and claims, serve to explain at least in part various principles, elements, or aspects of the disclosure. Embodiments of the disclosure are described more fully below with reference to the annexed drawings. However, various elements of the disclosure may be implemented in many different forms and should not be construed as limited to the implementations set forth herein. Like numbers refer to like elements throughout.

FIG. 1 shows an example computing system;

FIG. 2A shows an example computing system;

FIG. 2B shows an example computing system;

FIG. 2C shows an example computing system;

FIG. 3 shows an example computing system;

FIG. 4 shows an example method;

FIG. 5 shows an example method;

FIG. 6 shows an example method;

FIG. 7 shows an example method;

FIG. 8 shows an example method;

FIG. 9 shows an example method;

FIG. 10 shows an example method;

FIG. 11 shows an example method; and

FIG. 12 shows an example method.

### DETAILED DESCRIPTION

The disclosure recognizes and addresses, among other technical challenges, the issue of tracking network entities over time, across a network. Because accessing a ground-truth identity of the network entity is difficult, commonplace approaches rely on observable IDs in log data generated by probe devices within a network of multiple network entities being monitored. Those observable IDs may comprise, for example, Internet protocol (IP) addresses, domain names, media access control (MAC) addresses, email addresses, and so forth. The observable IDs are ephemeral IDs that exist only for a finite period of time and, thus, are temporarily associated with the network entity. Accordingly, when a cybersecurity product treats such observable IDs as static IDs—e.g., IDs that are perennial and may represent the network entity in more permanent fashion—inaccurate results may ensue. In this disclosure, by analyzing network log data spanning a particular time interval, associations between static IDs and ephemeral IDs corresponding to respective network entities may be generated and tracked during specific time periods encompassed by the particular time interval. Existing associations between static IDs and ephemeral IDs may be updated over time, also based on analysis of incoming network log data. Accordingly, in contrast to commonplace network entity tracking techniques, the tracking functionalities described herein may provide temporal relationships between ephemeral IDs and unique IDs for network entities.

The described tracking functionalities leverage static IDs to create time-aware associations between ephemeral IDs and static IDs. As a result, those functionalities may be readily applied to historical network log data and contemporaneous network log data to deliver accurate network entity tracking. Further, in sharp contrast to many existing technologies, the described tracking functionalities may be implemented in a decentralized fashion, without reliance on intrusive software agents. Accordingly, network entities may be readily tracked in computing systems where deployment of a software agent is not permitted or is otherwise unfeasible (as it might be the case in a network of Internet-of-Things (IoT) devices).

The functionalities described herein may be applied to cybersecurity. By tracking network entities, analytic platforms that evaluate activity data derived from source log data may identify malicious behavior within a network.

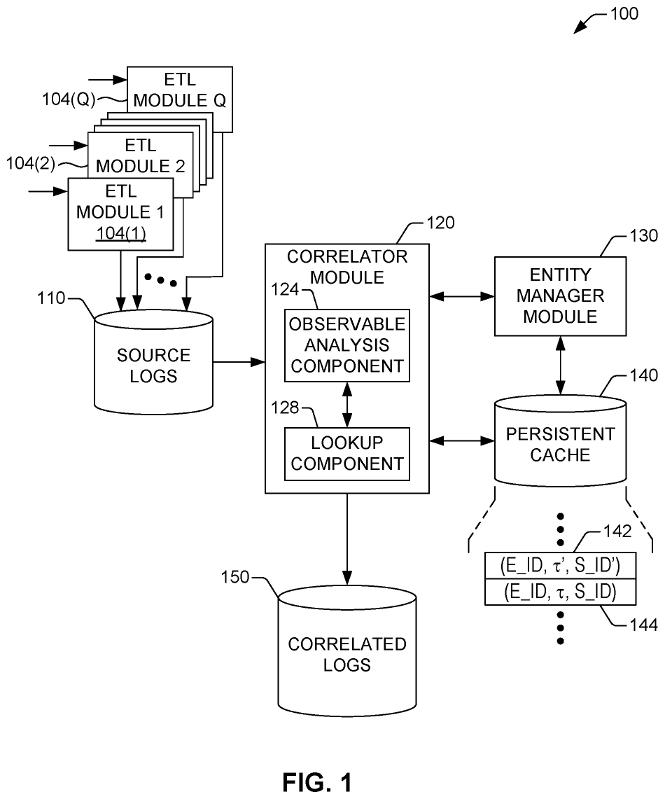

FIG. 1 shows an example computing system 100 to track network entities. The example computing system 100 comprises a data repository 110 (which may be referred to as source logs 110) that retains network log data. The network log data may be embodied in network log data defining a series of log messages. Each log message in that series may include activity data identifying an action topic. Extract, transform, load (ETL) modules, including a first ETL module 104(1), a second ETL module 104(2), and so forth up to a Q-th ETL module 104(Q) may generate, individually or in combination, the series of log messages. Although Q is shown as being greater than two, two ETL modules or one ETL module may be contemplated in some cases. The ETL modules 104(1)-104(Q) constitute an ETL layer. The one or multiple ETL modules 104(1)-104(Q) may generate the series of log messages from various source devices that generate log records of different types. As an example, log records may be dynamic host configuration protocol (DHCP) log records. Such records indicate when a machine obtains a new Internet protocol (IP) address. The machine may be a physical device or a virtual machine. As another example, log records may be active directory (AD) log records. Such records indicate when a user account gets a new username or email address. As yet another example, log records may be domain name system (DNS) log records. Such records may indicate transitions of Internet protocol (IP) addresses between domain names. Other types of network logs also may be contemplated, such as telemetry logs (e.g., network telemetry logs and endpoint telemetry logs) and event detection logs.

In some cases, multiple ETL modules 104(1)-104(Q) are functionally coupled to respective source devices (not depicted in FIG. 1), and operate on log records originating from such devices. A source device may generate DHCP log records and another source device may generate AD log records. Other source devices may generate log records of other types. By operating on those log records, the ETL modules 104(1)-104(Q) may generate streams of network log data and may retain those streams in the data repository 110. Additionally, by operating on the log records, the ETL modules 104(1)-104(Q) may format the log messages appropriately for further processing associated with tracking of network entities. Thus, the ETL layer eliminates the need for downstream components to contain information specifying formatting definitions for log data.

Regardless of their type, log records and activity data generated based on those log records comprise ephemeral IDs corresponding to respective network entities. An ephemeral ID is an identifier that can be temporarily associated with a network entity, such as a computer device or a computing virtual machine. The phrases/terms “ephemeral ID” and “temporary ID” may be used herein interchangeably. Examples of ephemeral ID types comprise IP address, domain name (DN), fully qualified domain name (FQDN), MAC address, username, email address, and similar types. Network log data may comprise time-dependent associations between ephemeral IDs and network entities. Such associations may be tracked and operated upon as is described hereinafter.

A correlator module 120 present in the example computing system 100 may access network log data corresponding to a defined time period Δt. The network log data may be accessed via an ingestion component (not depicted in FIG. 1) integrated into the correlator module 120. In some cases, the network log data may be a stream of data. In other cases, the network log data may be contained in a batch data file. The defined time period Δt may be contemporaneous with an analytics time period during which analytics evaluation is performed on network log data. In other words, the correlator module 120 may access real-time network log data for analysis, essentially as that data becomes available. In other cases, the time-period may be time-shifted relative to the analytics time period.

Network log data corresponding to a period of network activity may include ephemeral IDs that have not been observed in other periods of network activity. Such ephemeral IDs can be considered as new ephemeral IDs. Because an ephemeral ID may be associated with a network entity, the new ephemeral ID may be associated with a network entity not previously included or otherwise observed in the network log data. Thus, an association between the new ephemeral ID and a new static ID may be created, where the new static ID corresponds to that network entity. The correlator module 120 comprises an observable analysis component 124 that receives the network log data (e.g., a stream of data or a batch data file). The observable analysis component 124 may determine if an ephemeral ID present in the network log data is new during the defined time period Δt. Such a determination may be performed in several ways. In some cases, the observable analysis component 124 may determine if the ephemeral ID is absent from activity data within the network log data during another defined time period ΔT. Determining that the ephemeral ID is absent from the activity data during that other defined time period ΔT results in the ephemeral ID being deemed new because activity data corresponding to the ephemeral ID is unavailable and, thus, an association between the ephemeral ID and a network entity is unfeasible. That other defined time period ΔT may be greater than the defined time period Δt. As an example, ΔT may be equal to M days, with M a natural number greater than 1, and Δt may be 12 hours or 24 hours. Additionally, the defined time period ΔT may be overlapping with the time period Δt.

In other cases, also to determine if the ephemeral ID is new during the defined time period Δt, the observable analysis component 124 may determine if the ephemeral ID is absent from data storage during the defined time period Δt. The data storage may retain records defining respective associations between ephemeral and static IDs. Thus, to determine if the ephemeral ID is absent from the data storage, the observable analysis component 124 may cause a lookup component 128 to perform a query operation against the data storage. A null result of the query operation may indicate that the ephemeral ID is absent from the persistent cache 140. Thus, the ephemeral ID may be deemed new. The data storage can include a persistent cache 140 that permits performant storage and readout of data. The persistent cache 140 may be embodied in an in-memory key-value cache having low latency (of the order of 1 ms or less, for example). Latencies of the order of 10 ms also may be satisfactory. The persistent cache 140 is thus deemed to be a performant cache for storage and readout of key-value tuples (e.g., ordered sets of key-value elements, pairs, etc.). In one example, the persistent cache 140 is embodied in remote dictionary server (Redis).

Because a new ephemeral ID may be associated with a network entity that has not been previously observed in network log data, a static ID can be created to be associated with that network entity. A determination that the ephemeral ID is new may result in the observable analysis component 124 causing generation of a static ID. The static ID represents a network entity corresponding to the ephemeral ID during the defined time period. Causing the generation of the static ID may comprise directing a generator component (not depicted in FIG. 1) that is part of the correlator module 120 to perform a function call that results in the generation of a universally-unique identifier (UUID). In some cases, causing the generation of the static ID may comprise sending a request message for the static ID to an entity manager module 130 that generates static identifiers. The request message may comprise the ephemeral ID. The entity manager module 130 may receive the request message and may then generate the static ID. To that end, for example, the entity manager module 130 may perform the function call that results in the generation of the UUID. The entity manager module 130 assigns the UUID to the static ID that has been requested, and may send that static ID to the correlator module 120.

The correlator module 120, using the static ID, may store a record within the persistent cache 140, where the record defines a current association between the ephemeral ID and the static ID. The current association corresponds to the defined time period Δt. Storing the record may comprise storing a tuple within the persistent cache 140. The tuple may, for example, comprise a first element corresponding to the ephemeral ID and a second element corresponding to the static ID. The first element preceding the second element.

In some cases, the observable analysis component 124 may determine that the ephemeral ID present in the network log data, during the defined time period, is not new. That is, the ephemeral ID has been observed within activity data corresponding at least one other defined period. In those cases, the observable analysis component 124 may determine if a relationship between the ephemeral ID and a network entity has changed. More specifically, the observable analysis component 124 may determine if a change in an association between the ephemeral ID and a network entity is present. Such a determination may be accomplished in several ways. In example scenarios where the network log data contains activity data identifying changes in a network of devices being analyzed, action topics may identify, for example, that a DHCP lease has been assigned, renewed, or released. In some cases, the action topics may indicate that a machine (either a physical device or a virtual machine) has obtained a new IP address. In other cases, the action topics may indicate that a user account has obtained a new username or email address. Accordingly, the observable analysis component 124 may determine if a change in the association between the ephemeral ID and the network entity is present by determining if a transition of the ephemeral ID from the network entity to another network entity has occurred. In addition, or in some cases, the observable analysis component 124 may determine if a change in the association between the ephemeral ID and the network entity is present by determining if the ephemeral ID for the network entity changed. Further, or in other cases, the observable analysis component 124 may determine if a change in the association between the ephemeral ID and the network entity is present by determining if the ephemeral ID for the network entity has been discarded.

In such scenarios, the activity data may comprise physical network addresses (such as MAC addresses) associated with ephemeral IDs. A physical network address may embody a type of more stable ephemeral address. Accordingly, the observable analysis component 124 may determine if the change is present in the association between the ephemeral ID and the network entity by determining if a transition of the ephemeral ID from a physical network address to another physical network address has occurred. A determination that the change is present indicates that a relationship between the ephemeral ID and the network entity has changed.

In other example scenarios, the network log data contains activity data identifying two or more ephemeral IDs associated with the network entity. Hence, the observable analysis component 124 may use the two or more ephemeral IDs to determine if the change is present in the association between the ephemeral ID and the network entity. For example, the observable analysis component 124 may determine if a portion of the network log data indicates that each of the ephemeral ID and a second ephemeral ID correspond to the network entity. In case of an affirmative determination, the observable analysis component 124 may determine if the persistent cache 140 comprises a particular static ID for the ephemeral ID and a second particular static ID for the second ephemeral ID, where the second particular static ID is different from the particular static ID. In one example, the network entity may be embodied in a server device or a laptop computer, and the ephemeral ID may be an IP address and the second ephemeral ID may be a FQDN. The FQDN may be a more stable ephemeral address than the IP address. The observable analysis component 124 may cause the lookup component 128 to perform a query operation for the FQDN, against the persistent cache 140. As a result, the observable analysis component 124 may determine that the query operation yields the particular static ID. The observable analysis component 124 also may cause the lookup component 128 to perform a query operation for the IP address, against the persistent cache 140. As a result, the observable analysis component 124 may determine that the query operation yields the second particular static ID. As mentioned, the particular static ID and the second particular static ID are different from one another. Thus, such a difference within the persistent cache 140 may indicate that the IP address for the network entity has changed. As a result, a correspondence between the IP address and the network entity may be updated within one or more analytic modules that monitor behavior of the network entity using the IP address and ID thereof (e.g., the particular static ID or the second particular static ID).

Regardless of how it is accomplished, a determination that the ephemeral ID has changed may cause the observable analysis component 124 to determine an existing association between the ephemeral ID and a static ID associated with another network entity. Such a determination may be based on the change and existing network log data present in the persistent cache 140.

The observable analysis component 124 may update the existing association within the persistent cache 140. Such an update may result in a current association between the ephemeral ID and a second static ID (e.g., uniquely identifying and/or associated with the network entity) during the defined time period. To update the existing association within the persistent cache 140, the observable analysis component 124 may add the current association to the persistent cache 140, while maintaining the existing association within the persistent cache 140. To add the current association to the persistent cache 140, the observable analysis component 124 may store, within the persistent cache 140, a record defining the current association. The record may comprise a tuple having a first element corresponding to the ephemeral ID and a second element corresponding to the second static ID, where the first element precedes the second element.

After the existing association has been updated, the correlator module 120 may send a notification message to the entity manager module 130. An output component (not depicted in FIG. 1) integrated into the correlator module 120 may send the notification message, for example. Associations of ephemeral IDs to static IDs are time-aware in order to correctly handle log messages that become available to the correlator module 120 with a delay relative to a time that the log messages are generated. As such, a record defining an association between an ephemeral ID and a static ID may include a datum identifying a time that a log message having the ephemeral ID has been created. That log message may have been created by an ETL module, such as an ETL module 104(j), with j=1, 2 . . . , or Q, for example. A tuple that constitutes the record may include an element corresponding to such datum. The datum may be embodied in a timestamp, for example. The timestamp may be formatted in numerous ways, each representative of a time relative to time origin. In some cases, the timestamp may be formatted as combination of a date and a time-of-day. In other cases, the timestamp may be formatted as a number of seconds relative to the time origin (e.g., Unix epoch time). Accordingly, the persistent cache 140 may have a collection tuples including respective timestamps, each timestamp indicative of a time that a corresponding ephemeral ID has been recorded within a log message. For example, a tuple of the collection of tuples may be a 3-tuple and may be formatted as (ephemeral ID, static ID, τ), (ephemeral ID, τ, static ID), or (τ, ephemeral ID, static ID), where τ represents a timestamp. As another example, a tuple of the collection of tuples may be formatted to include other information, such as data identifying a tenant associated with a computing system that hosts the correlator module 120, or both the correlator module 120 and the entity manager 130; or data identifying an ephemeral ID type. A tuple may, for example, comprise an ordered set of data elements. A 3-tuple is an ordered set of three elements. As mentioned, examples of ephemeral ID types comprise IP address, DN, FQDN, MAC address, username, email address, and similar types. Regardless of the type of additional information, the last element of the tuple may correspond to the static ID. In scenarios where the persistent cache 140 is embodied in an in-memory key-value cache, the persistent cache may retain P-tuples. The first P−1 elements of a P-tuple may constitute a key and the P-th element constitutes a value. The value corresponds to a static ID, and one of the P−1 elements corresponds to an ephemeral ID and another one of the P−1 elements corresponds to a timestamp.

Schematic examples of tuples present in the persistent cache 140 are tuple 142 and tuple 144. The tuple 142 identifies a relationship between an ephemeral ID (E_ID) and a static ID (S_ID) at a time τ. The tuple 144 identifies a relationship between the ephemeral ID (E_ID) and another static ID (S_ID′) at another time τ′.

By incorporating a timestamp within a tuple stored in the persistent cache 140, the network entity corresponding to the static ID (e.g., a UUID) may be unambiguously tracked regardless of the time of creation of an ephemeral ID associated with the static ID. Thus, in sharp contrast to existing technologies, entity tracking as is described herein readily processes network log data obtained out-of-order and/or delayed relative to other network log data. The processing treats associations between ephemeral IDs and static IDs without temporal inconsistencies because timestamps maintain the relative time ordering of such associations. As an example, a first association between IP 10.0.0.1 and entity E_{A} (e.g., a host) may be recorded as starting at a time t_{A} (e.g., 10:00 AM on January 3rd). A second association between IP 10.0.0.1 and entity E_{B} (e.g., another host) may be recorded as starting at a time t_{B} (e.g., 11:00 AM on January 3rd). Such a scenario may occur when that IP address is dynamically allocated. For example, the IP address may be leased to E_{A} at time t_{A}. The lease may expire before or at time t_{B}. Upon expiration, the IP address may be dissociated from entity EA. The IP addressed can then be leased to the entity E_{B} at t_{B}. In cases where a log message including IP 10.0.0.1 becomes available to the correlator module 120 after the second association has been recorded, and the log message has been generated between times t_{A} and t_{B} (e.g., between 10:00 AM and 11:00 AM on January 3rd), for example, the observable analysis component 124 may assign IP 10.0.0.1 to entity E_{A}. The observable analysis component 124 may assign IP 10.0.0.1 to entity E_{B} for later available log messages including IP 10.0.0.1 and being generated after t_{B}.

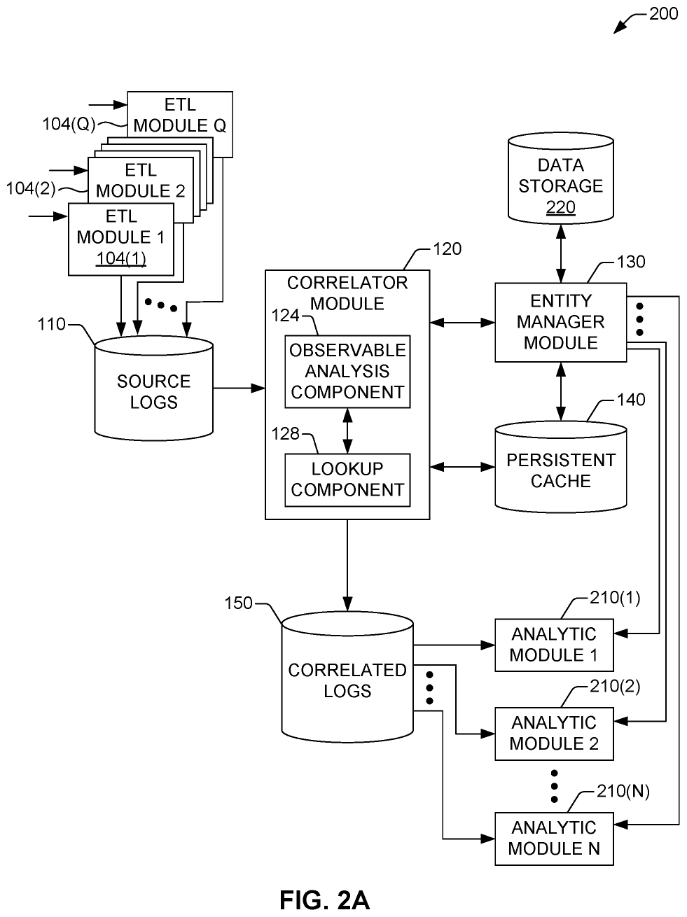

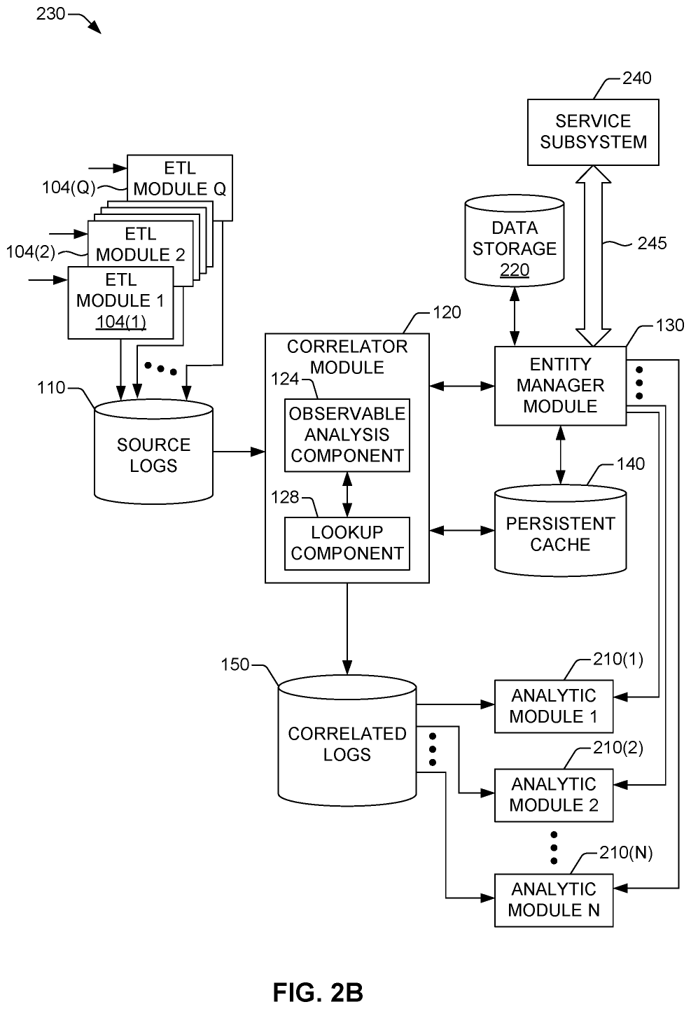

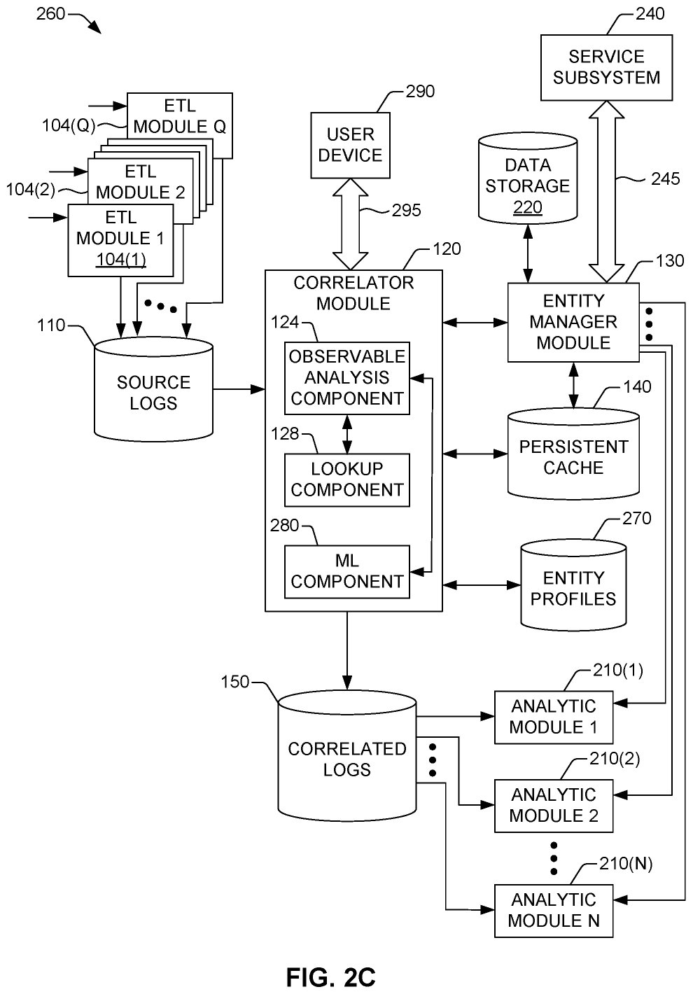

The correlator module 120 may use a current association between the ephemeral ID and static ID to send correlated network log data. The correlated network log data may be retained in a data repository 150 (referred to as correlated logs 150), and may comprise the series of log messages retained in the repository 110, with that series including static IDs instead of observables. The correlated network log data may comprise a first record comprising a tuple having a first element corresponding to the ephemeral ID and a second element corresponding to the second static ID, the first element preceding the second element. The correlator module 120 may send the correlated network log data to one or multiple components in an analytic layer. Such component(s) may monitor the network log data available to the correlator module 120. In one example, as is shown in example computing system 200 in FIG. 2A, the correlated network log data may be sent to multiple analytic modules, including a first analytic module 210(1), a second analytic module 210(2), and so forth up to an N-th analytic module 210(N). Although N is shown as being greater than two, two analytic modules may receive the correlated network log data in some cases.

Multiple instances of the correlator module 120 may analyze network log data available in the data repository 110. Hence, those multiple instances may determine a new entity concurrently. The entity manager module 130 may search the persistent cache 140 for duplicate ephemeral IDs (representing network entities) that have been generated during a defined period of time. Examples of the defined period of time include 12 hours, 24 hours, and 48 hours. The entity manager module 130 may search for duplicate ephemeral IDs at defined times, e.g., periodically, according to a schedule, or at times that satisfy a defined search criterion. For example, the entity manager module 130 may search for duplicate ephemeral IDs periodically, with a periodicity of, as several possible examples, 30 minutes, one hour, two hours, three hours, or six hours.

The entity manager module 130 may merge duplicate ephemeral IDs together in order to allow the correlator module 120 to horizontally scale without centralizing the decision making. To that end, the entity manager 130 may determine, based on a search, that a first tuple and a second tuple have an ephemeral ID in common. The entity manager module 130 may then merge the first tuple and the second tuple into a single tuple. The entity manager module 130 may update, based on the merger, the persistent cache 140 to retain the merged, single tuple.

As is shown in FIG. 2A, the entity manager module 130 may be functionally coupled to one or more memory devices 160 (referred to as data storage 160). While not depicted in FIG. 2A, the analytic modules 210(1)-210(N) also may be functionally coupled to the data storage 220. The data storage 160 may retain data and/or metadata corresponding to hosts (physical or virtual), user accounts, user sessions, and analytic results, for example. Such data and/or metadata may be arranged in a database, such as a relational database (e.g., a structured query language (SQL) database). By retaining the data and/or metadata in a database, the entity manager module 130 can perform a lookup operation against the database to obtain information corresponding to a network entity having a particular static ID at a particular time t. The lookup operation can yield, for example, ephemeral IDs and/or metadata corresponding to a host or a user. For example, metadata may be indicative of an operating system executing on the network entity; permission(s) assigned to a user account at the network entity; and the like.

Besides updating the persistent cache 140 responsive to a merger of a first network entity and a second network entity, the entity manager module 130 also may update references to one of the first network entity or the second network entity in the data storage 160—e.g., data within a relational database may be updated. In one example, responsive to merging network entity E_{A} into network entity E_{B}, the entity manager module 160 may update at least some analytic results that referenced network entity E_{A} to now reference network entity E_{B}. Additionally, the entity manager module 130 also can cleanup prior existing host entries and/or user-account entries, and also may consolidate user sessions.

Ephemeral ID-network entity associations may change over time. Network entities may transition from appearing unrelated during a period of time to being identified as the same by one or more particular ephemeral IDs during a subsequent period of time. A pair of network entities being treated as unrelated while in actuality may be a single network entity may create ambiguity in the tracking of such network entities. To remove such ambiguity, the entity manager module 130 may identify and logically merge such network entities into a single network entity. For example, host A may be defined with IP address 10.0.0.1, and host B may be defined with observable onedomain.io at a particular time. Network log data may identify, at a subsequent time, onedomain.io and 10.0.0.1 as being the same network entity. The entity manager module 130 may identify host A and host B, and may logically merge host B into host A, for example, to create a single entry within the persistent cache 140. To that point, the entity manager module 130 may access the persistent cache 140 and may determine, using records within the persistent cache 140, that a first tuple and a second tuple have a particular ephemeral ID in common. The particular ephemeral ID corresponds to a particular network entity, such as a host (physical or virtual) or a user account. The entity manager module 130 may merge the first tuple and the second tuple into a single tuple. Additionally, the entity manager module 130 may store the single tuple within the persistent cache 140.

The entity manager module 130 also may send a notification message indicative of the merger. In some cases, the notification may be sent to multiple analytic modules that have monitored activity of those network entities separately. The notification message may indicate that the network entities are to be treated as a single network entity. Hence, responsive to the notification message, the multiple analytic modules may merge separate historical datasets corresponding to the network entities into a single historical dataset. In that way, a more comprehensive dataset indicative of historical performance behavior (or historical network activity) of that single network entity becomes available. Access to such a more comprehensive dataset may reduce noise in the analysis of the historical performance.

One or more of the analytic modules 210(1) to 210(N) may operate on correlated network log data to evaluate various performance behaviors of one or more networks where network log data present in the data repository 110 have been originated. For example, the analytic modules 210(1) to 210(N), individually or in combination, may determine baseline performance behavior (referred to herein also as “historical performance behavior,” “historical network log data” and/or “historical network activity data”) for a network entity associated with a particular static ID. That baseline performance behavior may be determined using a machine-learning model (e.g., a regression model). For example, the machine-learning model may be trained or otherwise configured to identify baseline network activity data (indicative of and/or associated with the baseline performance behavior) within network activity data for the network entity, where the network activity data is included in the correlated network log data. Because the particular static ID is perennial, network activity data for the network entity over time may be reliably identified within the correlated network log data. Thus, the determination of baseline performance behavior based on the particular static ID and correlated network log data may be more reliable than a determination of baseline performance behavior based on an ephemeral ID. Based on the baseline performance behavior, the analytic modules 210(1) to 210(N), individually or in combination, may determine anomalous behavior of the network entity. For example, the particular static ID may be associated with an ephemeral ID during a particular time period based on network log data/activity data, but the network log data/activity data may also indicate that another particular static ID (e.g., for another network entity) is associated with the ephemeral ID during another (e.g., prior) time period. The change in association of the ephemeral ID from the particular static ID to the other particular static ID (e.g., for the other network entity) may be considered “anomalous behavior.” The anomalous behavior may represent malicious behavior effected by the network entity associated with the particular static ID. At least one of the analytic modules 210(1) to 210(N) may send a notification indicative of the malicious behavior (e.g., indicative of the network entity being associated with the particular static ID). The notification may be sent to one or more components downstream from the analytic layer comprising the analytic modules 210(1) to 210(N). For example, the notification may be sent to an analyst component (e.g., an autonomous bot) that monitors malicious activity within a network of computing devices. For example, the analyst component may determine malicious activity is present and/or associated with the network entity based on the notification and/or any of the network log data described herein.

Additionally, or as another example, one or more of the analytic modules 210(1) to 210(N) may operate on correlated network log data in order to track associations of a particular static ID with ephemeral IDs over time. By tracking such associations, the analytic modules 210(1) to 210(N), individually or in combination, may determine malicious behavior of a network entity (e.g., a physical device) corresponding to the static ID. For example, the analytic modules 210(1) to 210(N), individually or in combination, may determine an association between a first ephemeral ID and a static ID associated with a computing device (e.g., a network entity). The analytic modules 210(1) to 210(N), individually or in combination, may determine, based on baseline performance behaviors and a mapping of ephemeral IDs to the static ID, that the computing device is associated with malicious behavior. Further, the analytic modules 210(1) to 210(N), individually or in combination, may send a notification indicative of the malicious behavior. The notification may be sent to one or more components downstream from the analytic layer comprising the analytic modules 210(1) to 210(N). For example, the notification may be sent to the analyst component (e.g., the autonomous bot) that monitors malicious activity within the network of computing devices. For example, the analyst component may determine malicious activity is present and/or associated with the network entity and/or the computing device based on the notification and/or any of the network log data described herein.

In an example scenario, the analytic modules 210(1) to 210(N), individually or in combination, may operate on correlated network log data received from the data repository 150 to determine a first association between a first ephemeral ID and a static ID associated with a computing device, and also to determine a second association between a second ephemeral ID and the static ID associated with the computing device. Based on the first association and the second association, the analytic modules 210(1) to 210(N), individually or in combination, may update a security record associated with the computing device. The security record may be retained in the data storage 220, within a database therein, for example. By tracking a series of transitions between the first association and the second association, at least one of the analytic modules 210(1) to 210(N) may determine a risk attribute for the computing device. The risk attribute may be indicative of a probability that the computing device is a malicious actor.

A series of records retained in the persistent cache 140 may form a data signal that tracks network entities over time. The series of records combined with correlated network log data may convey time-dependent information on tracked network entities. As is shown in the example computing system 230 presented in FIG. 2B, a service subsystem 240 may access the time-dependent information in order to provide a service. For example, the service subsystem 240 may comprise, or be in communication with, the analyst component (e.g., the autonomous bot) that monitors malicious activity within the network of computing devices. The service subsystem 240 may be external to an entity tracking system that hosts the correlator module 120, the entity manager module 130, the persistent cache 140, and the data repository 150. That is, the computing subsystem may be physically and logically distinct from the entity tracking system. In one example, the service subsystem 240 may provide an analytics service that is separately hosted from the analytic layer that includes the analytic modules 210(1)-210(N).

To access that time-dependent information, the service subsystem 240 may send a query to the entity manager module 130. The query may be sent via a network 245 (represented by an open arrow in FIG. 2B and FIG. 2C). The network 245 may comprise wired link(s) and/or wireless link(s) and several network elements (such as routers or switches, concentrators, servers, and the like) that form a communication architecture having a defined footprint. The network 245 may be embodied in a local area network (LAN), a metropolitan area network (MAN), a wide area network (WAN), or a combination thereof. The query may include one or more criteria dictating desired attributes related to network entities (hosts and user accounts, for example). The network entities are represented by respective static IDs (e.g., UUIDs). In an example query, an attribute may be embodied in ephemeral ID, and one or multiple other attributes may define a time period. Thus, the example query may request information including values of ephemeral IDs over the defined time period.

The entity manager module 130 may receive the query, and may resolve the query by accessing the data repository 150 or the persistent cache 140, or both. The entity manager module 130 may receive the query via the network 245. The entity manager module 130 may then send correlated network log records or tuples, or a combination of both, to the service subsystem 240. The records and tuples comprise respective ephemeral IDs and static IDs. Such records or tuples may be sent via the network 245.

Probabilistic approaches for tracking entity changes or performing entity mergers also may be implemented. FIG. 2C shows an example computing system 260 that may implement such probabilistic approaches. In such approaches, the observable analysis component 124 may access attribute data that characterize a network entity, such as a machine (a physical device or a virtual machine) or a user account. The observable analysis component 124 may receive the attribute data from a data repository. In some cases, the observable analysis component 124 may generate the attribute data using historical network log data retained in the data repository 110, for example. The attribute data may define multiple profile attributes of the network entity during a particular time interval. The multiple profile attributes form an entity profile for the network entity. The entity profile characterizes the network entity within a network, and may serve as a digital fingerprint of the network entity. The observable analysis component 124 may store the entity profile in a data repository 270. As an example, in cases where the network entity is a host (physical or virtual), the multiple profile attributes may define software that typically runs on that host; ports that are commonly open; typical interactions between end-users and components (such as software applications) present in the host; connections that are typically made to either internal resources or external resources; a combination of the foregoing; or similar attributes.

The observable analysis component 124 may obtain network log data (e.g., a stream of data, a batch data file, etc.) and may determine presence or absence of profile attributes for an ephemeral ID (e.g., an IP address) within that data, during a defined time interval. The network log data may be obtained from the data repository 110. By determining a temporal average of similarity metrics in the space of profile attributes, the observable analysis component 124 may evaluate how likely it is that the ephemeral ID corresponds to another network entity (e.g., another host). For example, the similarity metrics comprise cosine similarity, Jaccard similarity coefficient, and various distances, such as Minkowski distance. The temporal average of similarity metrics is itself a similarity metric and may quantify a degree of similarity between the first network entity and the second network entity. Thus, in cases where that degree of similarity satisfies one or more criteria, the first ephemeral ID and the second ephemeral ID may be deemed to be indicative of a same network entity.

The correlator module 120, via the observable analysis component 124, may determine that one or multiple similarity metrics (or another type of quantity indicative of similarity) corresponding to a pair of network entities have respective values meeting or exceeding a threshold value. A similarity metric having a value that meets or exceeds the threshold value may convey that the first network entity and the second network entity may be the same network entity. The threshold value is configurable and may be defined interactively at runtime of the correlator module 120, for example. A pre-set value of the threshold value also may be defined at build time of the correlator module 120.

Based on the similarity metric(s) having respective values meeting or exceeding the threshold value, the correlator module 120 may prompt a user device 290 to supply feedback data indicating if the pair of network entities is to be merged. The user device 290 may be embodied in, for example, a server device, a personal computer (PC), a laptop computer, a tablet computer, or a smartphone. Prompting the user device 290 to provide such feedback data may include sending a request message to the user device to confirm merger of the pair of network entities. The request messages may be sent via a network 295 (represented by an open arrow in FIG. 2C). The network 295 may comprise wired link(s) and/or wireless link(s) and several network elements (such as routers or switches, concentrators, servers, and the like) that form a communication architecture having a defined footprint. The network 245 may be embodied in a LAN, a MAN, a WAN), or a combination thereof. The request message may include payload data indicating that the pair of network entities are candidates for merger. The user device 290 may have access to data and/or may apply heuristics that may indicate that the network entities in that pair of network entities are the same or distinct. The user device may send feedback data to the entity manager module 130. The feedback data may be sent via the network 295. The entity manager module 130 may merge the pair of network entities responsive to the feedback data identifying the pair of network entities as being the same.

In other cases, the correlator module 120 may send one or multiple similarity metrics corresponding to a pair of network entities to the entity manager module 130. The entity manager module 130 may automatically merge the pair of network entities responsive to the similarity metric(s) having respective values meeting or exceeding the defined threshold value.

The foregoing probabilistic approach may be more appropriate in scenarios where the network log data lacks activity data associated with DHCP actions or DNS actions, for example. Additionally, the correlator module 120 may use the feedback data involved in the foregoing approach as a data signal to learn to identify a pair of network entities as a candidate for merger or a non-candidate for merger. That data signal indicates whether a candidate for merger conveyed to the user device 290 is indeed to be merged. The data signal thus may form a learning dataset, effectively labeling data corresponding to a pair of network entities as either candidate or non-candidate. As is shown in FIG. 2B, the correlator module 120 may comprise a machine-learning (ML) component 280 that may implement, using the data signal, a learning process to generate a similarity model to classify a pair of network entities as being a candidate for merger or a non-candidate for merger. As an example, the learning process may be based on k-nearest-neighbors (k-NN) technique or a clustering technique. Over time, as the data signal is collected, the similarity model may be updated to yield improved quality of candidate identification. Application of the similarity model to network log data yields one or multiple similarity values (or similarity scores) during the time interval.

In some cases, the ML component 280 may implement, using the data signal, a learning process to generate another type of similarity model. Rather than identifying a pair of network entities as a candidate for merger or a non-candidate for merger, that other type of similarity model may identify profile attributes, and respective weights, to be used in a determination of a similarity metric for the pair of network entities. In other words, such a similarity model may identify a subspace of the space of profile attributes that may use to determine similarity metrics. The learning process may comprise a clustering technique that may identify such a subspace. Relying on clustering techniques may reduce the rate of false positives—e.g., rate of identification of a pair of network entities as a candidate for merger despite a merger not being appropriate. Over time, as the data signal is collected, the learning process may yield an updated similarity model that identifies a set of profile attributes that the observable analysis component 124 may use to determine an appropriate similarity metric for a pair of network entities. Hence, such a similarity model combined with a determination of similarity metric(s) may identify a candidate for merger.

As a result of that time-dependent refinement, the correlator module 120 may embody a dynamic identification system that may customize the identification of network entities to a computing system associated with the user device 290. Such a dynamic identification system may improve computational efficiency of that computing system.

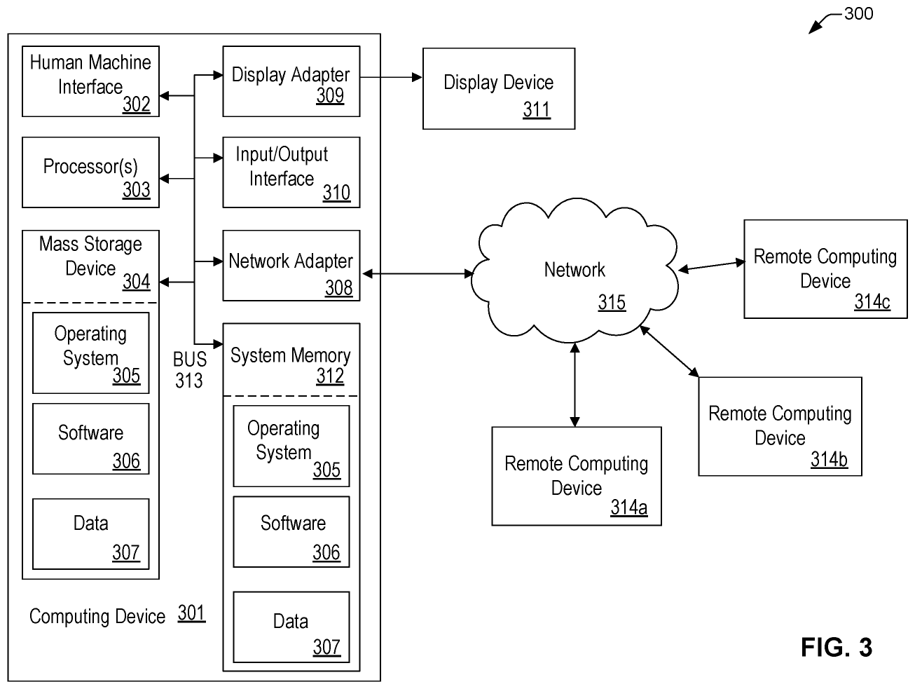

Entity tracking and other functionalities described herein may be implemented on the computing system 300 shown in FIG. 3 and described below. The computer-implemented methods and systems disclosed herein may utilize one or more computing devices to perform one or more functions in one or more locations. FIG. 3 is a block diagram depicting an example computing system 300 for performing the disclosed methods and/or implementing the disclosed systems. The computing system 300 is only an example of a computing system and is not intended to suggest any limitation as to the scope of use or functionality of system architecture. Neither should the computing system 300 be interpreted as having any dependency or requirement relating to any one or combination of components illustrated in FIG. 3. The computing system 300 shown in FIG. 3 may embody at least a portion of the example computing system 100 (FIG. 1), the example computing system 200 (FIG. 2A), the example computing system 230 (FIG. 2B), the example computing system 260 (FIG. 2C), or other computing systems described herein, and may implement the various functionalities described herein in connection with entity tracking. For example, one or more of the computing devices shown in the computing system 300 may comprise the correlator module 120, the entity manager module 130, the persistent cache 140, and the data repository 150 shown in FIG. 1. In some cases, the computing system 300 also may comprise the data repository 110 (FIG. 1).

The computer-implemented methods and systems in accordance with this disclosure may be operational with numerous other general purpose or special purpose computing system environments or configurations. Examples of well-known computing systems, environments, and/or configurations that may be suitable for use with the systems and methods comprise, but are not limited to, personal computers, server computers, laptop devices, and multiprocessor systems. Additional examples comprise set-top boxes, programmable consumer electronics, network PCs, minicomputers, mainframe computers, distributed computing systems that comprise any of the above systems or devices, and the like.

The processing of the disclosed computer-implemented methods and systems may be performed by software components. The disclosed systems and computer-implemented methods may be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods may also be practiced in grid-based and distributed computing systems where tasks are performed by remote processing devices that are linked through a communications network. In a distributed computing system, program modules may be located in both local and remote computer storage media including memory storage devices.

Further, the systems and computer-implemented methods disclosed herein may be implemented via a general-purpose computing device in the form of a computing device 301. The components of the computing device 301 may comprise one or more processors 303, a system memory 312, and a system bus 313 that couples various system components including the one or more processors 303 to the system memory 312. The system may utilize parallel computing.

The system bus 313 represents one or more of several possible types of bus structures, including a memory bus or memory controller, a peripheral bus, an accelerated graphics port, or local bus using any of a variety of bus architectures. The bus 313, and all buses specified in this description may also be implemented over a wired or wireless network connection and each of the subsystems, including the one or more processors 303, a mass storage device 304, an operating system 305, software 306, data 307, a network adapter 308, the system memory 312, an Input/Output interface 310, a display adapter 309, a display device 311, and a human-machine interface 302, may be contained within one or more remote computing devices 314a,b,c at physically separate locations, connected through buses of this form, in effect implementing a fully distributed system.

The computing device 301 typically comprises a variety of computer-readable media. Exemplary readable media may be any available media that is accessible by the computing device 301 and comprises, for example and not meant to be limiting, both volatile and non-volatile media, removable and non-removable media. The system memory 312 comprises computer readable media in the form of volatile memory, such as random access memory (RAM), and/or non-volatile memory, such as read only memory (ROM). The system memory 312 typically contains data such as the data 307 and/or program modules such as the operating system 305 and the software 306 that are immediately accessible to and/or are presently operated on by the one or more processors 303. For example, the software 306 may include the correlator module 120 (as is shown in FIG. 1 or FIG. 2C) and the entity manager module 130. The operating system 305 may be embodied in one of Windows operating system, Unix, or Linux, for example.

In another aspect, the computing device 301 may also comprise other removable/non-removable, volatile/non-volatile computer storage media. For example, FIG. 3 illustrates the mass storage device 304 which may provide non-volatile storage of computer code, computer readable instructions, data structures, program modules, and other data for the computing device 301. For example and not meant to be limiting, the mass storage device 304 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules may be stored on the mass storage device 304, including by way of example, the operating system 305 and the software 306. Each of the operating system 305 and the software 306 (or some combination thereof) may comprise elements of the programming and the software 306. The data 307 may also be stored on the mass storage device 304. The data 307 may be stored in any of one or more databases known in the art. Examples of such databases comprise, DB2®, Microsoft® Access, Microsoft® SQL Server, Oracle®, mySQL, PostgreSQL, and the like. The databases may be centralized or distributed across multiple systems. The software 306 may comprise, for example, the correlator module 120 and the entity manager 130.

In another aspect, the user may enter commands and information into the computing device 301 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices may be connected to the one or more processors 303 via the human-machine interface 302 that is coupled to the system bus 313, but may be connected by other interface and bus structures, such as a parallel port, game port, an IEEE 1394 Port (also known as a Firewire port), a serial port, or a universal serial bus (USB).

In yet another aspect, the display device 311 may also be connected to the system bus 313 via an interface, such as the display adapter 309. It is contemplated that the computing device 301 may have more than one display adapter 309 and the computing device 301 may have more than one display device 311. For example, the display device 311 may be a monitor, an LCD (Liquid Crystal Display), or a projector. In addition to the display device 311, other output peripheral devices may comprise components such as speakers (not shown) and a printer (not shown) which may be connected to the computing device 301 via the Input/Output Interface 310. Any operation and/or result of the methods may be output in any form to an output device. Such output may be any form of visual representation, including, but not limited to, textual, graphical, animation, audio, tactile, and the like. The display device 311 and computing device 301 may be part of one device, or separate devices.

The computing device 301 may operate in a networked environment using logical connections to one or more remote computing devices 314a,b,c. For example, a remote computing device may be a personal computer, portable computer, smartphone, a server device, a router device, a network computer, a peer device or other common network node, and so on. Logical connections between the computing device 301 and a remote computing device 314a,b,c may be made via a network 315, such as a LAN and/or a general WAN. Such network connections may be through the network adapter 308. The network adapter 308 may be implemented in both wired and wireless environments. In some cases, one or more of the remote computing devices 314a,b,c may embody the service subsystem 240 (FIG. 2B). In addition, or in other cases, a remote computing device of the remote computing devices 314a,b,c may embody the user device 290 (FIG. 3C). Accordingly, the network 315 may embody, for example, the network 245 or the network 295, or both.

For purposes of illustration, application programs and other executable program components such as the operating system 305 are illustrated herein as discrete blocks, although it is recognized that such programs and components reside at various times in different storage components of the computing device 301, and are executed by the one or more processors 303 of the computer. An implementation of the software 306 may be stored on or transmitted across some form of computer-readable media. Any of the disclosed methods may be performed by computer readable instructions embodied on computer-readable media. Computer-readable media may be any available media that may be accessed by a computer. By way of example and not meant to be limiting, computer-readable media may comprise “computer storage media” and “communications media.” “Computer storage media” comprise volatile and non-volatile, removable and non-removable media implemented in any methods or technology for storage of information such as computer-readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

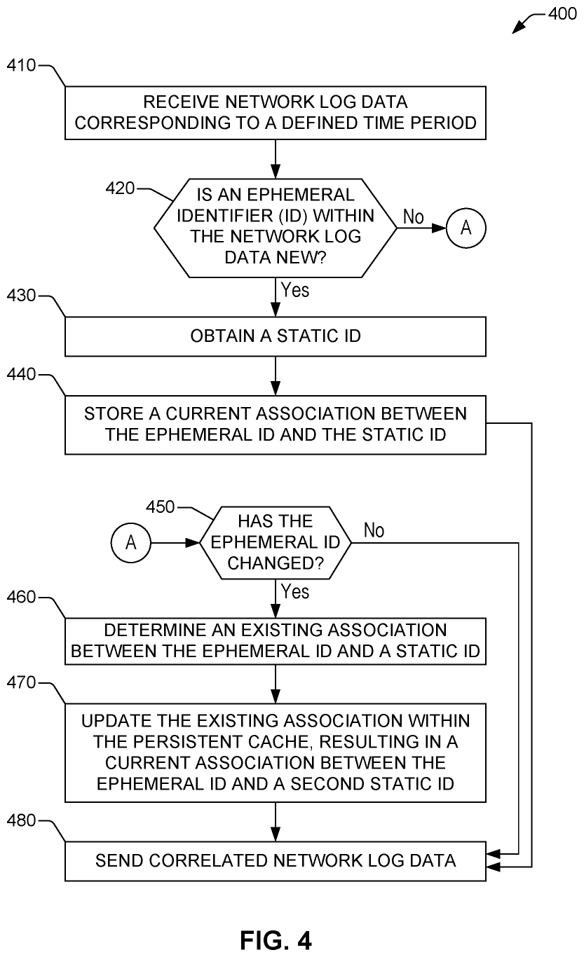

FIG. 4 shows a flowchart of an example method 400 for tracking network entities. A computing device or a system of computing devices (referred to herein as simply, the “system”) may implement the example method 400 in its entirety or in part. To that end, each one of the computing devices includes computing resources that may implement at least one of the blocks included in the example method 400. The computing resources comprise, for example, central processing units (CPUs), graphics processing units (GPUs), tensor processing units (TPUs), memory, disk space, incoming bandwidth, and/or outgoing bandwidth, interface(s) (such as I/O interfaces or APIs, or both); controller devices(s); power supplies; a combination of the foregoing; and/or similar resources. In one example, the system of computing devices may include programming interface(s); an operating system; software for configuration and/or control of a virtualized environment; firmware; and similar resources.

The system of computing devices may host the correlator module 120 (FIG. 1), amongst other software modules. The system may implement the example method 400 by executing one or multiple instances of the correlator module 120. Thus, the correlator module 120 may perform the operations corresponding to the blocks, individually or in combination, of the example method 400.

At block 410, the system (via the correlator module 120, for example) may receive network log data corresponding to a defined time period Δt. The defined time period may be contemporaneous with an analytics time period during which analytics evaluation is performed on network log data. In other cases, the time period may be shifted relative to the analytics time period. The network log data may define a series of log messages. Each log message in that series may include activity data identifying one or more action topics. The stream of data may be received from a data repository. In one example, the data repository is embodied in the data repository 110 (FIG. 1).

At block 420, the system (via the correlator module 120, for example) may determine if an ephemeral ID present in the network log data is new during the defined time period. In one example, determining if the ephemeral ID is new may include determining if activity data within the network log data excludes the ephemeral ID during another defined time period ΔT (e.g., the network log data does not contain, indicate, etc., the ephemeral ID). The other defined time period may be greater than the defined time period during which the novelty of the ephemeral ID is being evaluated. Additionally, the defined time period ΔT may be overlapping with the time period Δt. In another example, determining if the ephemeral ID is new may include determining if the ephemeral ID is absent from data storage during the defined time period Δt. The data storage may retain records defining respective associations between ephemeral and static IDs. The data storage may be embodied in, or may comprise, the persistent cache 140 (FIG. 1). The static IDs may comprise UUIDs.

An affirmative determination (“Yes” branch) at block 420 results in the flow of the example method 400 being directed to block 430, where the system (via the correlator module 120, for example) may obtain a static ID. Obtaining the static ID may comprise generating the static ID. In some cases, the system may generate the static ID via a component within the correlator module 120 (FIG. 1), for example. In other cases, the system may generate the static component via another component that generates static identifiers. In one example, that other component constitutes the entity manager module 130 (FIG. 1). Thus, the system also may host that component besides hosting the correlator module 120.

The static ID may be obtained in other ways. In some cases, obtaining the static ID may comprise sending a request message for the static ID to a component that generates static identifiers. The request message may comprise the ephemeral ID. The system may execute that component (e.g., may initiate a process) to cause the component to receive the request message. In response to the request message, the system (via the correlator module 120, for example) may receive the static ID. For example, the component that has received the request message may generate the static ID (e.g., a UUID) responsive to the request message, and may send the static ID to the system.

At block 440, the system (via the correlator module 120, for example) may store a current association between the ephemeral ID and the static ID. The current association corresponds to the defined time period Δt. The current association may be stored in the persistent cache, e.g., the persistent cache 140 (FIG. 1). In one example, the current association may be stored in a record within the persistent cache. As mentioned, the persistent cache may be embodied in an in-memory key-value cache (e.g., Redis). Storing the current association may comprise storing a tuple having a first element corresponding to the ephemeral ID and a second element corresponding to the static ID. The first element preceding the second element.

Back to referring to block 420, a negative determination (“No” branch) may result in the flow of the example method 400 being directed to block 450, where the computing device(s) may determine if the ephemeral ID has changed. More specifically, the computing device(s) may determine if a change in an association between the ephemeral ID and a network entity is present.

In scenarios where the network log data contains activity data identifying changes in a network of devices being analyzed—e.g., the network log data comprises DHCP log data or AD log data—action topics may identify, for example, that a DHCP lease has been assigned, renewed, or released. In some cases, the action topics may indicate that a machine (either a physical device or a virtual machine) has obtained a new IP address. In other cases, the action topics may indicate that a user account has obtained a new username or email address. Accordingly, determining if a change in the association between the ephemeral ID and the network entity is present may comprise determining if a transition of the ephemeral ID from the network entity to a second network entity has occurred. In addition, or in some cases, determining if a change in the association between the ephemeral ID and the network entity is present may comprise determining if the ephemeral ID for the network entity changed. Further, or in other cases, determining if a change in the association between the ephemeral ID and the network entity is present may comprise determining if the ephemeral ID for the network entity has been discarded.

In such scenarios, the activity data may comprise physical network addresses (e.g., MAC addresses) associated with ephemeral IDs. Determining if the change is present in the association between the ephemeral ID and the network entity may comprise determining if a transition of the ephemeral ID from a physical network address to another physical network address has occurred.

In other scenarios, the network log data contains activity data identifying two or more ephemeral IDs associated with the network entity. Hence, determining if the change is present in the association between the ephemeral ID and the network entity may comprise operations involving the two or more ephemeral IDs. Such operations may comprise, for example, determining if a portion of the network log data is indicative of each of the ephemeral ID and a second ephemeral ID corresponding to the network entity. Additionally, in case of an affirmative determination, the operations may also comprise determining if a persistent cache comprises a particular static ID for the ephemeral ID and a second particular static ID for the second ephemeral ID.

As an example, the network entity may be embodied in a server device or a laptop computer, and the ephemeral ID may be embodied in an IP address and the second ephemeral ID may be embodied in an FQDN. The computing device(s) may determine that a query operation for the FQDN in the persistent cache (e.g., persistent cache 140 (FIG. 1)) yields the particular static ID, and also may determine that a query operation for the IP address yields the second particular ID. Such a mismatch within the cache may indicate that the IP address for the network entity has changed.

An affirmative determination (“Yes” branch) at block 450 may result in the flow of the example method 400 being directed to block 460, where the system (via the correlator module 120, for example) may determine an existing association between the ephemeral ID and a static ID (e.g., uniquely identifying and/or associated with another network entity). Such a determination may be based on the change and existing network log data present in the persistent cache.

At block 470, the system (via the correlator module 120, for example) may update the existing association within the persistent cache. Such an update may result in a current association between the ephemeral ID and a second static ID (e.g., uniquely identifying and/or associated with the network entity) during the defined time period. As an example, updating the existing association within the persistent cache may comprise adding the current association to the persistent cache, while maintaining the existing association within the persistent cache. Adding the current association may comprise storing, within the persistent cache, a record defining the current association. The record may comprise a tuple having a first element corresponding to the ephemeral ID and a second element corresponding to the second static ID, the first element preceding the second element. Because the association between the ephemeral ID and the second static ID may be time dependent, the tuple also may include timestamp or another type of datum indicative of a time that the ephemeral ID has been recorded within a log message. Inclusion of the timestamp or such a datum maintains the relative order of the ephemeral ID and the second static ID within the tuple.

Additionally, the correlator module 120, for example, may send a notification message. The notification message may indicate, for example, the existing association and/or that the existing association has been updated within the persistent cache. Additionally, or in the alternative, the notification message may indicate: the current association; the record defining the current association; the tuple; the ephemeral ID; the first and/or second static IDs; the timestamp or other type of datum indicative of the time that the ephemeral ID was recorded within a log message; a combination thereof, and/or the like. The correlator module 120 may send the notification message to the entity manager module 130.

The system (via the correlator module 120, for example) may use a current association between the ephemeral ID and static ID to send correlated network log data at block 480. The correlated network log data comprises a first record comprising a tuple having a first element corresponding to the ephemeral ID and a second element corresponding to the second static ID, the first element preceding the second element.

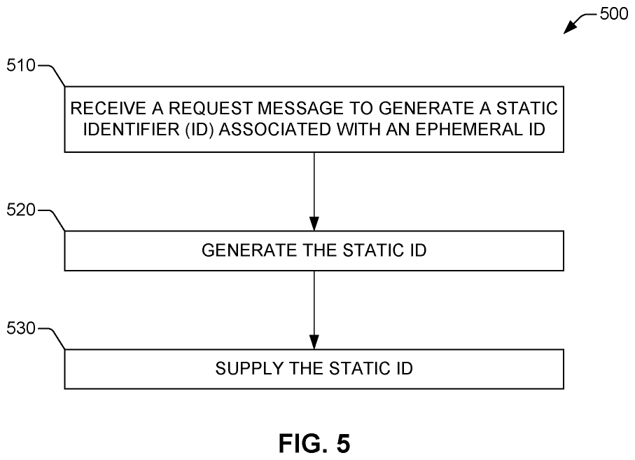

FIG. 5 shows a flowchart of an example method 500 for creating static IDs to track network entities. A computing device or a system of computing devices (referred to herein as simply, the “system”) may implement the example method 500 in its entirety or in part. To that end, each one of the computing devices includes computing resources that may implement at least one of the blocks included in the example method 500. The computing resources comprise, for example, CPUs, GPUs, TPUs, memory, disk space, incoming bandwidth, and/or outgoing bandwidth, interface(s) (such as I/O interfaces or APIs, or both); controller devices(s); power supplies; a combination of the foregoing; and/or similar resources. In one example, the system of computing devices may include programming interface(s); an operating system; software for configuration and/or control of a virtualized environment; firmware; and similar resources.

The system of computing devices may host the entity manager module 130 (FIG. 1), amongst other software modules. The system may implement the example method 500 by executing one or multiple instances of the entity manager module 130. Thus, the entity manager module 130 may perform the operations corresponding to the blocks, individually or in combination, of the example method 500.

At block 510, the system (via the entity manager module 130, for example) may receive a request message to generate a static ID associated with an ephemeral ID. The request message may comprise the ephemeral ID. As mentioned, examples of the ephemeral ID comprise an Internet protocol (IP) address, a MAC address, or an email address. The request message may be received responsive to the ephemeral ID being absent from a correlated network log data originating from multiple network log messages pertaining to a defined time period. The request message may be received from a component (e.g., the observable analysis component 124) that also is hosted by the system.

At block 520, the system (via the entity manager module 130, for example) may generate the static ID. As mentioned, the static ID may be embodied in a UUID. Thus, in some cases, generating the static ID may comprise generating the UUID. At block 530, the system (via the entity manager module 130, for example) may supply the static ID. Supplying the static ID may comprise sending the static ID to the component that sent the request message received at block 510. Thus, in one example, the entity manager module 130 may send the static ID to the observable analysis component 124 (FIG. 1). Additionally, or in other cases, supplying the static ID may comprise storing the static ID in data storage and configuring an interface, such as an API, to permit access to the stored static ID via a function call. The component that sent the request message may execute the function call in order to access the static ID.

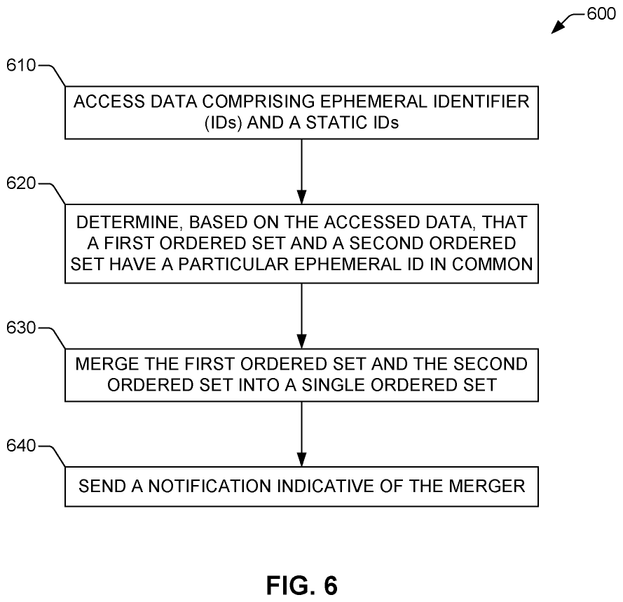

As is described herein, tracking network activity data of a network entity based on static IDs may provide more reliable information on performance behavior of the network entity over time. In contrast, tracking network activity data based on ephemeral IDs may create more fragmented, less reliable information on performance behavior of network entities because different ephemeral IDs may actually correspond to a same network entity or because a same ephemeral ID may actually correspond to different network entities. Accordingly, various processes are provided in this disclosure to update relationships between ephemeral IDs and static IDs in order to remove redundant identifiers and, thus, reduce ambiguity in the tracking of performance behavior of a network entities over time. FIGS. 6-8 illustrates examples of such processes.

FIG. 6 shows a flowchart of an example method 600 for managing static IDs used to track network entities. A computing device or a system of computing devices (referred to herein as simply, the “system”) may implement the example method 600 in its entirety or in part. To that end, each one of the computing devices includes computing resources that may implement at least one of the blocks included in the example method 600. The computing resources comprise, for example, CPUs, GPUs, TPUs, memory, disk space, incoming bandwidth, and/or outgoing bandwidth, interface(s) (such as I/O interfaces or APIs, or both); controller devices(s); power supplies; a combination of the foregoing; and/or similar resources. In one example, the system of computing devices may include programming interface(s); an operating system; software for configuration and/or control of a virtualized environment; firmware; and similar resources.

The system of computing devices may host the entity manager module 130 (FIG. 1), amongst other software modules. The system may implement the example method 600 by executing one or multiple instances of the entity manager module 130. Thus, the entity manager module 130 may perform the operations corresponding to the blocks, individually or in combination, of the example method 600.

At block 610, the system (via the entity manager module 130, for example) may access data comprising ephemeral IDs and static IDs. The accessed data may be formatted to include multiple ordered sets, where each ordered set includes an ephemeral ID and a static ID after the ephemeral ID. In some cases, the system may access a data repository containing the data. The data can include, for example, multiple records comprising respective tuples. In one example, the data repository is embodied in the persistent cache 140 (FIG. 1). The system may access the data repository at defined times, e.g., periodically, according to a schedule, or at times that satisfy a defined criterion. For example, the system may access the data repository at a time interval of 30 minutes, one hour, two hours, three hours, or six hours. In one example, the data repository is embodied in the persistent cache 140 (FIG. 1).

At block 620, the system (via the entity manager module 130, for example) may determine, based on the data that have been accessed, that a first ordered set of the multiple ordered sets and a second ordered set of the multiple ordered sets have a particular ephemeral ID in common. The particular ephemeral ID corresponds to a particular network entity, such a host (physical or virtual) or a user account.

At block 630, the system (via the entity manager module 130, for example) may merge the first ordered set and the second ordered set into a single ordered set. Merging the first ordered set and the second ordered set may comprise removing the second ordered set from the data repository (e.g., persistent cache 140 (FIG. 1)). At block 640, the computing device(s) may send a notification indicative of the merger. In some cases, the notification may be sent to one or more analytic components present in an analytic layer. For example, a first analytic component of the analytic component(s) may be embodied in one of the analytic modules 210(1)-210(N) (FIG. 2A).

While not illustrated in FIG. 6, the system (via the entity manager module 130) also may update references to one of a first network entity (e.g., E_{A}) or a second network entity (E_{B}) corresponding to the ephemeral ID in a second data repository (e.g., the data storage 220). For example, the system (via the entity manager module 130) may update data within a relational database retained in the second data repository. In one example, responsive to the merger at block 630, the entity manager module 130 may update at least some analytic results that referenced network entity E_{A} to now reference network entity E_{B}. Additionally, the entity manager module 130 also can cleanup prior existing host entries and/or user-account entries, and also may consolidate user sessions.

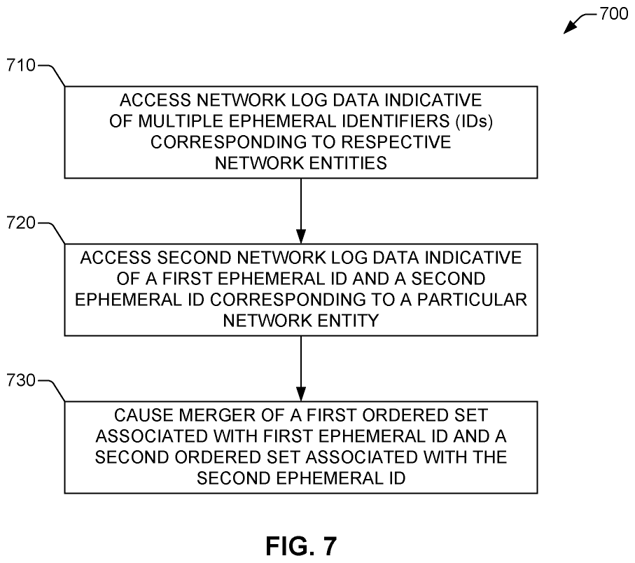

FIG. 7 shows a flowchart of an example method 700 for managing static IDs used to track network entities. A computing device or a system of computing devices (referred to herein as simply, the “system”) may implement the example method 700 in its entirety or in part. To that end, each one of the computing devices includes computing resources that may implement at least one of the blocks included in the example method 700. The computing resources comprise, for example, CPUs, GPUs, TPUs, memory, disk space, incoming bandwidth, and/or outgoing bandwidth, interface(s) (such as I/O interfaces or APIs, or both); controller devices(s); power supplies; a combination of the foregoing; and/or similar resources. In one example, the system of computing devices may include programming interface(s); an operating system; software for configuration and/or control of a virtualized environment; firmware; and similar resources.

The system of computing devices may host the correlator module 120 (FIG. 1), amongst other software modules. The system may implement the example method 700 by executing one or multiple instances of the correlator module 120. Thus, the correlator module 120 may perform the operations corresponding to the blocks, individually or in combination, of the example method 700.

At block 710, the system (via the correlator module 120, for example) may access network log data indicative of multiple ephemeral IDs corresponding to respective network identities (e.g., a combination of hosts and user accounts). A first ephemeral ID of the multiple ephemeral IDs may correspond to a first network entity of the respective network entities. For example, the first ephemeral ID may be IP address 10.0.0.1, and the first network entity may be a first particular host. A second ephemeral ID of the multiple ephemeral IDs may correspond to a second network entity. For example, the second ephemeral ID may be the hostname onedomain.io, and the second network entity may be a second particular host. The network log data may be associated with a particular time or a time interval.

The network log data may be retained within a data repository containing log messages generated by an ETL layer based on log records. In one example, the data repository may be embodied in the data repository 110 (FIG. 1). The log records may comprise DNS log records and DHCP log records, and the network log data may define log messages that include activity data for various network entities. The activity data may comprise an activity statement linking the first ephemeral ID (e.g., IP address 10.0.01) and the particular network entity. The activity data also may comprise another activity statement linking the second ephemeral ID (e.g., hostname onedomain.io) and the second particular network entity.

At block 720, the system (via the correlator module 130, for example) may access second network log data associated with a second particular time or a second time interval. The second network log data may be indicative of a first ephemeral ID and a second ephemeral ID corresponding to a particular network entity. The second network log data also may be retained within the data repository. The second network log data also may originate from log records comprising DNS log records and DHCP log records. The second network log data may define log messages that include second activity data for various second network entities. Thus, the second activity data may include an activity statement linking the first ephemeral ID (e.g., IP address 10.0.01) to the particular network entity. Additionally, the second activity data may include another activity statement linking the second ephemeral ID (e.g., hostname onedomain.io) to the particular network entity.

At block 730, the system (via the correlator module 120, for example) may cause a merger of a first ordered set associated with the first ephemeral ID and a second ordered set associated with the second ephemeral ID. Specifically, the first ordered set may include the first ephemeral ID, a timestamp corresponding to the second particular time or the second time interval, and a first static ID. The second ordered set may include the second ephemeral ID, the timestamp, and a second UUID. Causing the merger of the first ordered set and the second ordered set may comprise sending, via the correlator module 120, for example, a request to another module to merge the first ordered set and the ordered set. The system may also host that other module. In some cases, the other module may be embodied in, or may comprise, the entity manager module 130 (FIG. 1). Thus, the system (via the entity manager module 130, for example) may merge the first ordered set and the second ordered set. Merging the first ordered set and the second ordered set may comprise removing the second ordered set from the persisting cache (e.g., persistent cache 140 (FIG. 1)). Such a merger may be responsive to the request to merge the first and second ordered sets.

The module that merges the first ordered set and the second ordered set may send a notification indicative of the merger. In some cases, as mentioned, that module may be embodied in the entity manager module 130. Thus, the entity manager module 130 may send the notification to one or more analytic components present in an analytic layer. For example, a first analytic component of the analytic component(s) may be embodied in one of the analytic modules 210(1)-210(N) (FIG. 2A). As also mentioned, the system also may host the entity manager module 130. Thus, the system (via the entity manager module 130, for example) may send the notification indicative of the merger. Further, the system (via the entity manager module 130) also may update references to one of a first network entity (e.g., E_{A}) or a second network entity (E_{B}) corresponding to the ephemeral ID in a second data repository (e.g., the data storage 220). For example, the system (via the entity manager module 130) may update data within a relational database retained in the second data repository. In one example, responsive to the merger of the first network entity and the second network entity, the entity manager module 130 may update at least some analytic results that referenced network entity E_{A} to now reference network entity E_{B}. Additionally, to remove references to both E_{A} and E_{B}, the entity manager module 130 also can revise prior existing host entries and/or user-account entries, and also may consolidate user sessions.

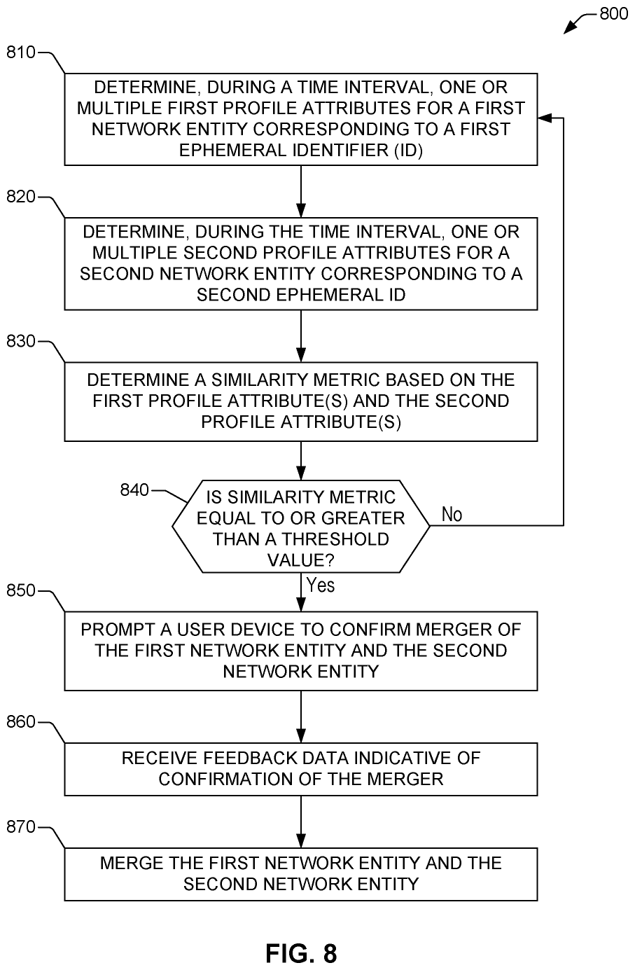

FIG. 8 shows a flowchart of an example method 800 for managing static IDs used to track network entities. A computing device or a system of computing devices (referred to herein as simply, the “system”) may implement the example method 800 in its entirety or in part. To that end, each one of the computing devices includes computing resources that may implement at least one of the blocks included in the example method 800. The computing resources comprise, for example, CPUs, GPUs, TPUs, memory, disk space, incoming bandwidth, and/or outgoing bandwidth, interface(s) (such as I/O interfaces or APIs, or both); controller devices(s); power supplies; a combination of the foregoing; and/or similar resources. In one example, the system of computing devices may include programming interface(s); an operating system; software for configuration and/or control of a virtualized environment; firmware; and similar resources.

The system of computing devices may host the correlator module 120 (FIG. 1) and the entity manager module 130 (FIG. 1), amongst other software modules. The system may implement the example method 800 by executing one or multiple instances of the correlator module 120 and one or multiple instances of the entity manager module 130. Thus, the correlator module 120 may perform the operations corresponding to one or more blocks, individually or in combination, of the example method 800. Additionally, the entity manager module 130 may perform other operations corresponding to one or more blocks, individually or in combination, of the example method 800.

At block 810, the system (via the correlator module 120, for example) may determine, during a time interval, one or multiple first profile attributes for a first network entity corresponding to a first ephemeral ID. The first profile attribute(s) may be determined using network log data during the time interval. For example, the system may access profile data defining an entity profile for the network entity.

At block 820, the system (via the correlator module 120, for example) may determine, during the time interval, one or multiple second profile attributes for a second network entity corresponding to a second ephemeral ID. The second profile attribute(s) may be determined using network log data during the time interval.

At block 830, the system (via the correlator module 120, for example) may determine a similarity metric based on the first profile attributes and the second profile attributes. As mentioned, examples of the similarity metric comprise cosine similarity, Jaccard similarity coefficient, and various distances, such as Minkowski distance. The similarity metric quantifies, based on the first and second profile attributes, a degree of similarity between the first network entity and the second network entity. Thus, in cases where that degree of similarity satisfies one or more criteria, the first ephemeral ID and the second ephemeral ID may be deemed to be indicative of a same network entity. Accordingly, the first network entity and second network entity may be disambiguated.

The one or more criteria may be defined in terms of a threshold value, where similarity metrics being equal to or exceeding the threshold value can satisfy the one or more criteria. At block 840, the system (via the correlator module 120, for example) may determine if a similarity metric is equal to or greater than a threshold value. The threshold value is configurable and may be defined interactively at runtime of the correlator module 120, for example. A negative determination (“No” branch) at block 840 may result in the flow of the example method 800 returning to block 810. That is, in cases where the first network entity and the second network entity may be deemed dissimilar, the determination of profile attributes of other network entities can be continued.

An affirmative determination (“Yes” branch) at block 840 conveys that the first network entity and the second network entity may be a same network entity. Rather than disambiguating the first network entity and the second network entity in response to the affirmative determination, such an affirmative determination may result in the flow of the example method 800 continuing to block 850. At that block, the system (via the correlator module 120, for example) may prompt a user device to confirm merger of the first network entity and the second network entity. Merging the first network entity and the second entity can disambiguate those network entities. Prompting the user device in such fashion may include sending a request message to the user device to confirm merger of the first network entity and the second network entity. The user device may send feedback data indicating to proceed with the merger of the first network entity and the second network entity or to reject the merger. The feedback data thus may control the merger (or disambiguation) of the first network entity and the second network entity.

At block 860, the system (via the entity manager module 130, for example) may receive feedback data indicative of confirmation of the merger. That is, the feedback data may indicate to proceed with the merger. At block 870, the system (via the entity manager module 130, for example) may merge the first network entity and the second network entity. As mentioned, the first network entity and the second network entity may be represented by respective records within a data repository (e.g., the persistent cache 140 (FIG. 1)). A first record representing the first entity may comprise a first tuple. Each one of the first tuple and the second tuple has an ephemeral ID and a static ID after the ephemeral ID. Merging the first network entity and the second network entity may include updating the first and second records to have a static ID in common, for example.

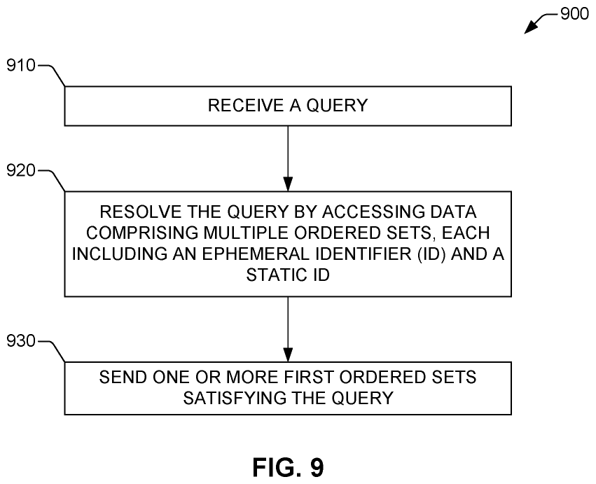

FIG. 9 shows a flowchart of an example method 900 for accessing time-dependent information on tracked network entities. A computing device or a system of computing devices (referred to herein as simply, the “system”) may implement the example method 900 in its entirety or in part. To that end, each one of the computing devices includes computing resources that may implement at least one of the blocks included in the example method 900. The computing resources comprise, for example, CPUs, GPUs, TPUs, memory, disk space, incoming bandwidth, and/or outgoing bandwidth, interface(s) (such as I/O interfaces or APIs, or both); controller devices(s); power supplies; a combination of the foregoing; and/or similar resources. In one example, the system of computing devices may include programming interface(s); an operating system; software for configuration and/or control of a virtualized environment; firmware; and similar resources.

The system of computing devices may host the entity manager module 130 (FIG. 1), amongst other software modules. The system may implement the example method 900 by executing one or multiple instances of the entity manager module 130. Thus, the entity manager module 130 may perform the operations corresponding to the blocks, individually or in combination, of the example method 900.

At block 910, the system (via the entity manager module 130, for example) may receive a query. The query may be received from a computing system that is external to the system. In some cases, that computing system is remotely located relative to the system. In other cases, the computing system is co-located with the system. In one example, the computing system may be embodied in, or may comprise, the service subsystem 240 (FIG. 2B). The query may include one or multiple criteria dictating desired attributes related to network entities (hosts and user accounts, for example). The network entities are represented by respective static IDs (e.g., UUIDs). In an example query, an attribute may be an ephemeral ID, and one or multiple other attributes may define a time period. Thus, the example query may request information including values of ephemeral IDs over the defined time period.

At block 920, the system (via the entity manager module 130, for example) may resolve the query by accessing data comprising multiple ordered sets. Each one of the multiple ordered sets comprises an ephemeral ID and a static ID after the ephemeral ID. The data may be accessed from a data repository that may be embodied in the persistent cache 140 (FIG. 1), for example. The data repository may contain multiple records comprising respective ordered sets (or tuples) where each ordered set comprises an ephemeral ID and a static ID after the ephemeral ID.

At block 930, the system (via the entity manager module 130, for example) may send one or more ordered sets satisfying the query. The one or more ordered sets may be sent to the computing device that originated the query or to a third-party computing device. Such ordered set(s) may form a data signal that may be consumed by other computing systems, whether or not those computing systems originate the query.

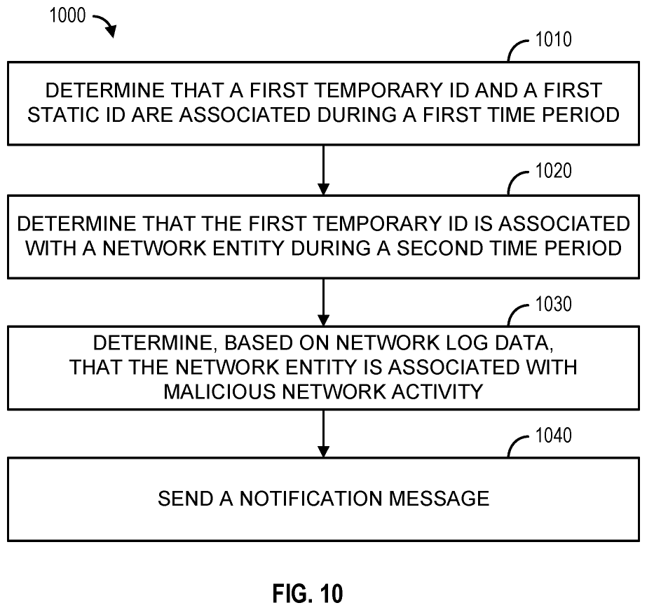

FIG. 10 shows a flowchart of an example method 1000 for tracking network entities. A computing device or a system of computing devices (referred to herein as simply, the “system”) may implement the example method 1000 in its entirety or in part. To that end, each one of the computing devices includes computing resources that may implement at least one of the blocks included in the example method 1000. The computing resources comprise, for example, central processing units (CPUs), graphics processing units (GPUs), tensor processing units (TPUs), memory, disk space, incoming bandwidth, and/or outgoing bandwidth, interface(s) (such as I/O interfaces or APIs, or both); controller devices(s); power supplies; a combination of the foregoing; and/or similar resources. In one example, the system of computing devices may include programming interface(s); an operating system; software for configuration and/or control of a virtualized environment; firmware; and similar resources.

The system of computing devices may host the correlator module 120 and/or the entity manager module 130 (FIG. 1), amongst other software modules. The system may implement the example method 1000 by executing one or multiple instances of the correlator module 120 and/or the entity manager module 130. Thus, the correlator module 120 and/or the entity manager module 130 may perform the operations corresponding to the blocks, individually or in combination, of the example method 1000.

At block 1010, the system may determine that a first temporary identifier (ID) (a first ephemeral ID) and a first static ID are associated during a first time period. For example, the system may determine that the first temporary ID and the first static ID are associated during the first time period based on network log data. The first static ID may uniquely identify a first network entity. For example, the first static ID may comprise a universally-unique identifier (UUID) that identifies the first network entity. The first temporary ID may comprise an IP address, a domain name (DN), a fully qualified domain name (FQDN), a MAC address, a username, an email address, a combination thereof, and/or the like (e.g., associated with the first network entity).

At block 1020, the system may determine that the first temporary ID is associated with a network entity (referred to in this section as the “second network entity”) during a second time period. For example, the system may determine that the first temporary ID is associated with the second network entity during the second time period based on the network log data. The first time period may comprise a prior/past time period, and the second time period may comprise a present/current time period.

At block 1030, the system may determine that the second network entity is associated with malicious network activity. The system may determine that the second network entity is associated with malicious network activity based on the first temporary ID being associated with the first static ID during the first time period as well as the first temporary ID being associated with the second network entity during the second time period. As noted above, the first time period may be prior to the second time period. In such a scenario, the system may determine that the second network entity is associated with malicious network activity based on the network log data indicating that the second network entity was associated with a second static ID, which may uniquely identify the second network entity, during the first time period.

The system may determine that the second static ID is associated with anomalous behavior. For example, the system may determine that the second static ID is associated with anomalous behavior based on the first temporary ID being associated with the first static ID during the first time period. Additionally, or in the alternative, the system may determine that the second static ID is associated with anomalous behavior based on the first temporary ID being associated with the second network entity during the second time period. The system may determine that the second network entity is associated with malicious network activity based on the second static ID being associated with the anomalous behavior.

At block 1040, the system may send a notification message. The notification message may indicate the second network entity is associated with malicious network activity. The notification message may be sent to one or more components downstream from the analytic layer comprising the analytic modules 210(1) to 210(N). For example, the notification message may be sent to an analyst component (e.g., an autonomous bot). The analyst component may monitor malicious activity within a network of computing devices that comprises the first network entity and the second network entity. The analyst component may determine that malicious activity is present and/or associated with the second network entity based on the notification message.

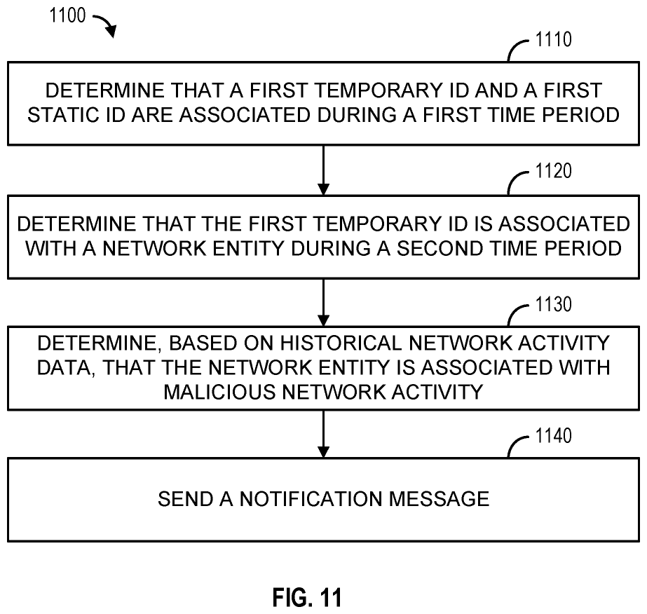

FIG. 11 shows a flowchart of an example method 1100 for tracking network entities. A computing device or a system of computing devices (referred to herein as simply, the “system”) may implement the example method 1100 in its entirety or in part. To that end, each one of the computing devices includes computing resources that may implement at least one of the blocks included in the example method 1100. The computing resources comprise, for example, central processing units (CPUs), graphics processing units (GPUs), tensor processing units (TPUs), memory, disk space, incoming bandwidth, and/or outgoing bandwidth, interface(s) (such as I/O interfaces or APIs, or both); controller devices(s); power supplies; a combination of the foregoing; and/or similar resources. In one example, the system of computing devices may include programming interface(s); an operating system; software for configuration and/or control of a virtualized environment; firmware; and similar resources.

The system of computing devices may host the correlator module 120 and/or the entity manager module 130 (FIG. 1), amongst other software modules. The system may implement the example method 1100 by executing one or multiple instances of the correlator module 120 and/or the entity manager module 130. Thus, the correlator module 120 and/or the entity manager module 130 may perform the operations corresponding to the blocks, individually or in combination, of the example method 1100.

At block 1110, the system may determine that a first temporary identifier (ID) (a first ephemeral ID) and a first static ID are associated during a first time period. For example, the system may determine that the first temporary ID and the first static ID are associated during the first time period based on network log data. The first static ID may be associated with and/or may uniquely identify a first network entity. For example, the first static ID may comprise a universally-unique identifier (UUID) that identifies the first network entity. The first temporary ID may comprise an IP address, a domain name (DN), a fully qualified domain name (FQDN), a MAC address, a username, or an email address, a combination thereof, and/or the like (e.g., associated with the first network entity).

At block 1120, the system may determine that the first temporary ID is associated with a network entity (referred to in this section as the “second network entity”) during a second time period. For example, the system may determine that the first temporary ID is associated with the second network entity during the second time period based on the network log data. The first time period may comprise a prior/past time period, and the second time period may comprise a present/current time period.

At block 1130, the system may determine that the second network entity is associated with malicious network activity based on historical network activity data. The historical network activity may be indicative of the second network entity having been associated with a second static ID during the first time period. The second static ID may uniquely identify the second network entity. The system may determine that the second network entity is associated with malicious network activity based on the second network entity having been associated with the second static ID during the first time period (e.g., based on the historical network activity data) and the fact that first temporary ID was associated with the second network entity during the second time period.

In some examples, the system may determine that the second network entity is associated with malicious network activity based on the first temporary ID being associated with the first static ID during the first time period as well as the first temporary ID being associated with the second network entity during the second time period.

The system may determine that the second static ID is associated with anomalous behavior. For example, the system may determine that the second static ID is associated with anomalous behavior based on the first temporary ID being associated with the first static ID during the first time period as well as the first temporary ID being associated with the second network entity (e.g., which is not associated with the first static ID) during the second time period. The system may determine that the second network entity is associated with malicious network activity based on the second static ID being associated with the anomalous behavior.

At block 1140, the system may send a notification message. The notification message may indicate the second network entity is associated with malicious network activity. The notification message may be sent to one or more components downstream from the analytic layer comprising the analytic modules 210(1) to 210(N). For example, the notification message may be sent to an analyst component (e.g., an autonomous bot). The analyst component may monitor malicious activity within a network of computing devices that comprises the first network entity and the second network entity. The analyst component may determine that malicious activity is present and/or associated with the second network entity based on the notification message.

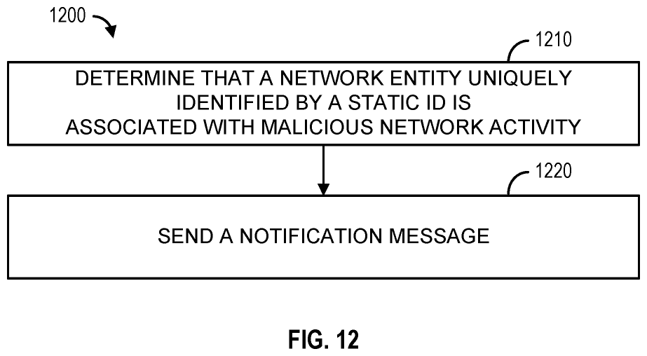

FIG. 12 shows a flowchart of an example method 1200 for tracking network entities. A computing device or a system of computing devices (referred to herein as simply, the “system”) may implement the example method 1200 in its entirety or in part. To that end, each one of the computing devices includes computing resources that may implement at least one of the blocks included in the example method 1200. The computing resources comprise, for example, central processing units (CPUs), graphics processing units (GPUs), tensor processing units (TPUs), memory, disk space, incoming bandwidth, and/or outgoing bandwidth, interface(s) (such as I/O interfaces or APIs, or both); controller devices(s); power supplies; a combination of the foregoing; and/or similar resources. In one example, the system of computing devices may include programming interface(s); an operating system; software for configuration and/or control of a virtualized environment; firmware; and similar resources.

The system of computing devices may host the correlator module 120 and/or the entity manager module 130 (FIG. 1), amongst other software modules. The system may implement the example method 1200 by executing one or multiple instances of the correlator module 120 and/or the entity manager module 130. Thus, the correlator module 120 and/or the entity manager module 130 may perform the operations corresponding to the blocks, individually or in combination, of the example method 1200.

The system may determine that a first temporary identifier (ID) (a first ephemeral ID) and a first static ID are associated during a first time period. For example, the system may determine that the first temporary ID and the first static ID are associated during the first time period based on network log data. The first static ID may uniquely identify a first network entity. For example, the first static ID may comprise a universally-unique identifier (UUID) that identifies the first network entity. The first temporary ID may comprise an IP address, a domain name (DN), a fully qualified domain name (FQDN), a MAC address, a username, an email address, a combination thereof, and/or the like (e.g., associated with the first network entity).

The system may determine that the first temporary ID is associated with a second static ID during a second time period. For example, the system may determine that the first temporary ID is associated with the second static ID during the second time period based on the network log data. At block 1210, the system may determine that a network entity uniquely identified by the second static ID is associated with malicious network activity. The second static ID may comprise a universally-unique identifier (UUID) that identifies the network entity (referred to in this section as the “second network entity”).

The first time period may comprise a prior/past time period, and the second time period may comprise a present/current time period. Accordingly, the system may determine that the second network entity is associated with malicious network activity based on (1) the first temporary ID being associated with the first static ID during the first/prior time period; (2) the first temporary ID being associated with the second static ID during the second/current time period; and (3) the second network entity being uniquely identified by the second static ID.

In some example, the system may determine that the second network entity is associated with anomalous behavior. For example, the system may determine that the second network entity is associated with anomalous behavior based on the first temporary ID being associated with the first static ID during the first time period and based on the first temporary ID being associated with the second static ID during the second time period. Based on the second network entity being associated with anomalous behavior, the system may determine that the second network entity is associated with malicious network activity.

At block 1220, the system may send a notification message. The notification message may indicate the second network entity is associated with malicious network activity. The notification message may be sent to one or more components downstream from the analytic layer comprising the analytic modules 210(1) to 210(N). For example, the notification message may be sent to an analyst component (e.g., an autonomous bot). The analyst component may monitor malicious activity within a network of computing devices that comprises the first network entity and the second network entity. The analyst component may determine that malicious activity is present and/or associated with the second network entity based on the notification message.

It is to be understood that the methods and systems described here are not limited to specific operations, processes, components, or structure described, or to the order or particular combination of such operations or components as described. It is also to be understood that the terminology used herein is for the purpose of describing example embodiments only and is not intended to be restrictive or limiting.

As used herein the singular forms “a,” “an,” and “the” include both singular and plural referents unless the context clearly dictates otherwise. Values expressed as approximations, by use of antecedents such as “about” or “approximately,” shall include reasonable variations from the referenced values. If such approximate values are included with ranges, not only are the endpoints considered approximations, the magnitude of the range shall also be considered an approximation. Lists are to be considered exemplary and not restricted or limited to the elements comprising the list or to the order in which the elements have been listed unless the context clearly dictates otherwise.

Throughout the specification and claims of this disclosure, the following words have the meaning that is set forth: “comprise” and variations of the word, such as “comprising” and “comprises,” mean including but not limited to, and are not intended to exclude, for example, other additives, components, integers, or operations. “Include” and variations of the word, such as “including” are not intended to mean something that is restricted or limited to what is indicated as being included, or to exclude what is not indicated. “May” means something that is permissive but not restrictive or limiting. “Optional” or “optionally” means something that may or may not be included without changing the result or what is being described. “Prefer” and variations of the word such as “preferred” or “preferably” mean something that is exemplary and more ideal, but not required. “Such as” means something that serves simply as an example.

Operations and components described herein as being used to perform the disclosed methods and construct the disclosed systems are illustrative unless the context clearly dictates otherwise. It is to be understood that when combinations, subsets, interactions, groups, etc. of these operations and components are disclosed, that while specific reference of each various individual and collective combinations and permutation of these may not be explicitly disclosed, each is specifically contemplated and described herein, for all methods and systems. This applies to all aspects of this application including, but not limited to, operations in disclosed methods and/or the components disclosed in the systems. Thus, if there are a variety of additional operations that may be performed or components that may be added, it is understood that each of these additional operations may be performed and components added with any specific embodiment or combination of embodiments of the disclosed systems and methods.

Embodiments of this disclosure may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof, whether internal, networked, or cloud-based.

Embodiments of this disclosure have been described with reference to diagrams, flowcharts, and other illustrations of computer-implemented methods, systems, apparatuses, and computer program products. Each block of the block diagrams and flowchart illustrations, and combinations of blocks in the block diagrams and flowchart illustrations, respectively, may be implemented by processor-accessible instructions. Such instructions may include, for example, computer program instructions (e.g., processor-readable and/or processor-executable instructions). The processor-accessible instructions may be built (e.g., linked and compiled) and retained in processor-executable form in one or multiple memory devices or one or many other processor-accessible non-transitory storage media. These computer program instructions (built or otherwise) may be loaded onto a general-purpose computer, special purpose computer, or other programmable data processing apparatus to produce a machine. The loaded computer program instructions may be accessed and executed by one or multiple processors or other types of processing circuitry. In response to execution, the loaded computer program instructions provide the functionality described in connection with flowchart blocks (individually or in a particular combination) or blocks in block diagrams (individually or in a particular combination). Thus, such instructions which execute on the computer or other programmable data processing apparatus create a means for implementing the functions specified in the flowchart blocks (individually or in a particular combination) or blocks in block diagrams (individually or in a particular combination).

These computer program instructions may also be stored in a computer-readable memory that may direct a computer or other programmable data processing apparatus to function in a particular manner, such that the instructions stored in the computer-readable memory produce an article of manufacture including processor-accessible instruction (e.g., processor-readable instructions and/or processor-executable instructions) to implement the function specified in the flowchart blocks (individually or in a particular combination) or blocks in block diagrams (individually or in a particular combination). The computer program instructions (built or otherwise) may also be loaded onto a computer or other programmable data processing apparatus to cause a series of operations to be performed on the computer or other programmable apparatus to produce a computer-implemented process. The series of operations may be performed in response to execution by one or more processor or other types of processing circuitry. Thus, such instructions that execute on the computer or other programmable apparatus provide operations for implementing the functions specified in the flowchart blocks (individually or in a particular combination) or blocks in block diagrams (individually or in a particular combination).

Accordingly, blocks of the block diagrams and flowchart diagrams support combinations of means for performing the specified functions in connection with such diagrams and/or flowchart illustrations, combinations of operations for performing the specified functions and program instruction means for performing the specified functions. Each block of the block diagrams and flowchart illustrations, and combinations of blocks in the block diagrams and flowchart illustrations, may be implemented by special purpose hardware-based computer systems that perform the specified functions or operations, or combinations of special purpose hardware and computer instructions.

The methods and systems may employ artificial intelligence techniques such as machine learning and iterative learning. Examples of such techniques include, but are not limited to, expert systems, case-based reasoning, Bayesian networks, behavior-based AI, neural networks, fuzzy systems, evolutionary computation (e.g. genetic algorithms), swarm intelligence (e.g. ant algorithms), and hybrid intelligent systems (e.g. expert inference rules generated through a neural network or production rules from statistical learning).

While the computer-implemented methods, apparatuses, devices, and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is in no way intended that an order be inferred, in any respect. This holds for any possible non-express basis for interpretation, including: matters of logic with respect to arrangement of operations or operational flow; plain meaning derived from grammatical organization or punctuation; the number or type of embodiments described in the specification.

It will be apparent to those skilled in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
determining, based on network log data, that a first temporary identifier (ID) and a first static ID are associated during a first time period, wherein the first static ID uniquely identifies a first network entity;
determining, based on the network log data, that the first temporary ID is associated with a second network entity during a second time period;
determining, based on the first temporary ID being associated with the first static ID during the first time period, and based on the first temporary ID being associated with the second network entity during the second time period, that the second network entity is associated with malicious network activity; and
sending a notification message, wherein the notification message indicates the second network entity is associated with malicious network activity.

2. The method of claim 1, wherein the first time period comprises a prior time period, and wherein the second time period comprises a current time period.

3. The method of claim 1, wherein determining that the second network entity is associated with malicious network activity comprises:
determining, based on the first temporary ID being associated with the first static ID during the first time period, and based on the first temporary ID being associated with the second network entity during the second time period, that a second static ID that uniquely identifies the second network entity is associated with anomalous behavior; and
determining, based on the second static ID being associated with the anomalous behavior, that the second network entity is associated with malicious network activity.

4. The method of claim 1, wherein determining that the second network entity is associated with malicious network activity comprises determining, based on the network log data, that the second network entity was associated with a second static ID, uniquely identifying the second network entity, during the first time period, wherein the first time period is prior to the second time period.

5. The method of claim 1, wherein determining that the second network entity is associated with malicious network activity comprises:
determining a second static ID that uniquely identifies the second network entity; and
determining, based on historical network activity data associated with the second static ID, and based on the network log data, that the second network entity is associated with malicious network activity.

6. The method of claim 1, wherein the first temporary ID comprises an IP address, a domain name (DN), a fully qualified domain name (FQDN), a MAC address, a username, or an email address.

7. The method of claim 1, wherein the first static ID comprises a universally-unique identifier (UUID).

8. A method comprising:
determining, based on network log data, that a first temporary identifier (ID) and a first static ID are associated during a first time period, wherein the first static ID is associated with a first network entity;
determining, based on the network log data, that the first temporary ID is associated with a second network entity during a second time period;
determining, based on historical network activity data associated with a second static ID, and based on the network log data, that the second network entity is associated with malicious network activity, wherein the historical network activity data indicates the second static ID is associated with the second network entity; and
sending a notification message, wherein the notification message indicates the second network entity is associated with malicious network activity.

9. The method of claim 8, wherein the first static ID uniquely identifies the first network entity, and wherein the second static ID uniquely identifies the second network entity.

10. The method of claim 8, wherein the historical network activity data is indicative of the second network entity being associated with the second static ID during the first time period.

11. The method of claim 8, wherein the first time period is prior to the second time period.

12. The method of claim 8, wherein determining that the second network entity is associated with malicious network activity comprises:
determining, based on the first temporary ID being associated with the first static ID during the first time period, and based on the first temporary ID being associated with the second network entity during the second time period, that the second static ID is associated with anomalous behavior; and
determining, based on the second static ID being associated with the anomalous behavior, that the second network entity is associated with malicious network activity.

13. The method of claim 8, wherein the first temporary ID comprises an IP address, a domain name (DN), a fully qualified domain name (FQDN), a MAC address, a username, or an email address.

14. The method of claim 8, wherein the first static ID comprises a first universally-unique identifier (UUID), and wherein the second static ID comprises a second UUID.

15. A method comprising:
determining, based on network log data indicating a first temporary identifier (ID) is associated with a first static ID during a first time period, and based on the network log data indicating the first temporary ID is associated with a second static ID during a second time period, that a network entity uniquely identified by the second static ID is associated with malicious network activity; and
sending a notification message, wherein the notification message indicates the network entity is associated with malicious network activity.

16. The method of claim 15, wherein the first time period comprises a prior time period, and wherein the second time period comprises a current time period.

17. The method of claim 15, wherein the first static ID uniquely identifies another network entity.

18. The method of claim 15, wherein determining that the network entity is associated with malicious network activity comprises:
determining, based on the first temporary ID being associated with the first static ID during the first time period, and based on the first temporary ID being associated with the second static ID during the second time period, that the network entity uniquely identified by the second static ID is associated with anomalous behavior; and
determining, based on the network entity uniquely identified by the second static ID being associated with the anomalous behavior, that the network entity is associated with malicious network activity.

19. The method of claim 15, wherein the first temporary ID comprises an IP address, a domain name (DN), a fully qualified domain name (FQDN), a MAC address, a username, or an email address associated with another network entity.

20. The method of claim 15, wherein the first static ID comprises a universally-unique identifier (UUID) for another network entity.
